(19) United States
(12) Patent Application Publication
(10) Pub. No.: US 2026/0070356 A1
(43) Pub. Date: Mar. 12, 2026

(54) PRINTING APPARATUS AND STORAGE CASSETTE

(71) Applicant: CANON KABUSHIKI KAISHA, Tokyo (JP)

(72) Inventors: MAYU OZAWA, Kanagawa (JP); KOKI KUDO, Kanagawa (JP); YASUNORI MATSUMOTO, Kanagawa (JP); SHO TAKAHASHI, Kanagawa (JP); HIROSHI YOSHINO, Kanagawa (JP); YUKI EMOTO, Tokyo (JP); MOTOYUKI TAGUCHI, Tokyo (JP)

(21) Appl. No.: 19/324,408

(22) Filed: Sep. 10, 2025

(30) Foreign Application Priority Data
Sep. 11, 2024 (JP) 2024-157728

(51) Int. Cl. B41J 13/10; B41J 13/00; B41J 13/02; B41J 13/03; B41J 29/00

(52) U.S. Cl. CPC B41J 13/103; B41J 13/0018; B41J 13/025; B41J 13/03; B41J 29/00

(57) ABSTRACT

A printing apparatus including: a housing; a feed roller, disposed in the housing, that feeds a sheet; a printing unit configured to print onto the sheet fed by the feed roller, and a storage cassette capable of being attached to and removed from the housing, the storage cassette storing the sheet, wherein the storage cassette includes a sheet separation unit capable of contacting the feed roller, and the printing apparatus comprises a regulating unit, disposed in the housing, configured to regulate rotation of the feed roller in conjunction with removal of the storage cassette from the housing.

### BACKGROUND

### Field of the Technology

The present disclosure relates to a printing apparatus and a storage cassette.

### Description of the Related Art

A technique is known in which a sheet stored in a storage cassette is fed to a printing apparatus. Japanese Patent Laid-Open No. 2006-151655 discloses a sheet material supply apparatus including an apparatus body and a storage cassette, the storage cassette having a stacking unit in which a sheet material is stacked and which is capable of moving up and down, and which is attached to the apparatus body in a withdrawable manner. This past sheet material supply apparatus feeds the sheet material, which is fed downstream in a conveyance direction by a feed roller, by separating the sheet material one sheet at a time in a state where the sheet material is nipped between a separation pad provided in the storage cassette and a separation roller provided in the apparatus body.

### SUMMARY

The present disclosure provides a technique for suppressing shifts in a rotation position of a feed roller.

The present disclosure in one aspect provides a printing apparatus comprising: a housing; a feed roller, disposed in the housing, that feeds a sheet; a printing unit configured to print onto the sheet fed by the feed roller; and a storage cassette capable of being attached to and removed from the housing, the storage cassette storing the sheet, wherein the storage cassette includes a sheet separation unit capable of contacting the feed roller, and the printing apparatus comprises a regulating unit, disposed in the housing, configured to regulate rotation of the feed roller in conjunction with removal of the storage cassette from the housing.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is an exterior view of a printing apparatus according to one embodiment of the present disclosure.

FIG. 2 is an exterior view of the printing apparatus of FIG. 1 equipped with a plurality of optional apparatuses.

FIG. 3 is a diagram illustrating a form in which a storage cassette is removed from the printing apparatus illustrated in FIG. 1.

FIG. 4 is a diagram illustrating a form in which a removable unit is removed from the printing apparatus illustrated in FIG. 1.

FIG. 5 is a diagram illustrating a form in which an opening/closing member is open in the printing apparatus illustrated in FIG. 1.

FIG. 6 is a diagram illustrating a form in which an opening/closing member is open in the printing apparatus illustrated in FIG. 1.

FIG. 7 is a schematic diagram illustrating internal structures of the printing apparatus and the optional apparatuses illustrated in FIG. 2.

FIG. 8 is a perspective view of a printing unit.

FIG. 9 is a cross-sectional view taken along line D-D in FIG. 8.

FIG. 10 is a diagram illustrating a state in which a cover and a feed tray are pulled out from the printing apparatus illustrated in FIG. 2.

FIG. 11 is a schematic diagram illustrating the internal structure of the printing apparatus illustrated in FIG. 10.

FIG. 12 is an exterior view of a printing apparatus 1A illustrated in FIG. 2, in which an opening/closing member is open.

FIG. 13 is a plan view of the printing apparatus 1A illustrated in FIG. 2, in which the opening/closing member is open.

FIGS. 14A and 14B are perspective views of the periphery of a slot.

FIG. 15 is a perspective view of the storage cassette.

FIG. 16 is an explanatory diagram illustrating the configuration of the storage cassette.

FIGS. 17A and 17B are cross-sectional views along F-F in FIG. 16.

FIG. 18 is a cross-sectional view along E-E in FIG. 15.

FIGS. 19A to 19C are operation diagrams illustrating an L-side cam and follower.

FIG. 20 is an operation diagram illustrating an L-side cam and a separation cam.

FIG. 21 is a perspective view illustrating part of the internal configuration of an apparatus body.

FIGS. 22A and 22B are explanatory diagrams illustrating feed operations.

FIGS. 23A to 23C are diagrams illustrating rotational regulation action of a regulating unit.

FIGS. 24A and 24B are explanatory diagrams illustrating storage cassette attachment/removal sensing operations.

FIG. 25 is a flowchart illustrating initialization control.

FIGS. 26A and 26B are diagrams illustrating a delay mechanism.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

As with the past technique, in an apparatus that separates and feeds a sheet in a state where a roller in the apparatus body and a sheet separation unit in the storage cassette are in contact, the rotation position of the roller may shift from the feed start position when the storage cassette is removed or the like. When the rotation position of the roller shifts, sheets may be fed in multiple, or the like.

### Overview of Printing Apparatus

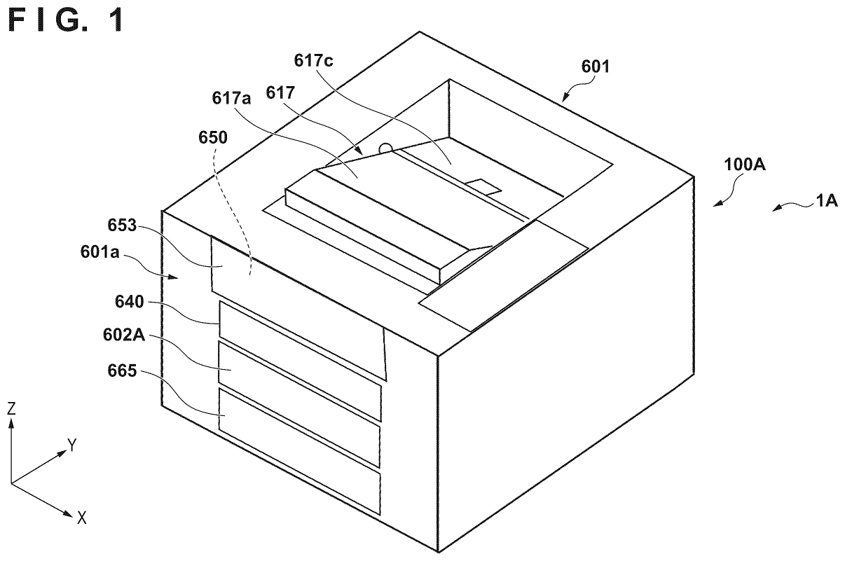

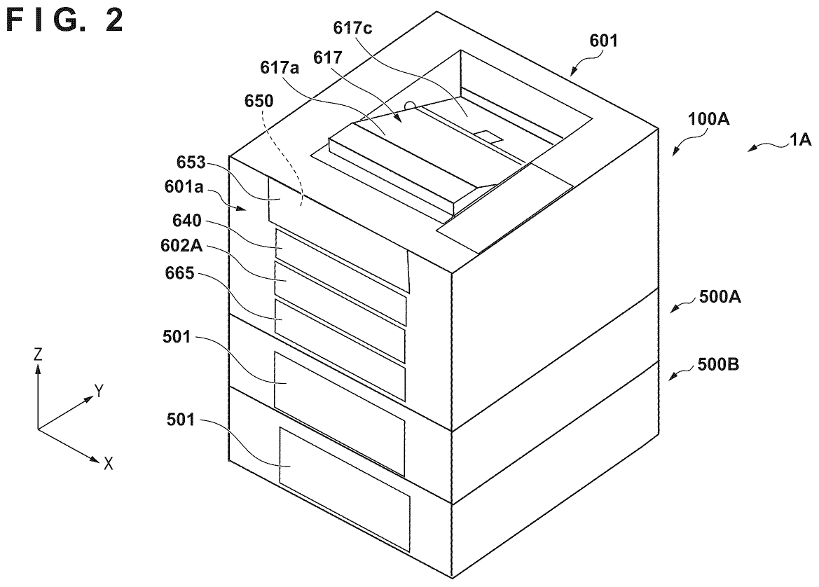

FIG. 1 is an exterior view of a printing apparatus 1A according to one embodiment of the present disclosure. A plurality of optional apparatuses can be attached to the printing apparatus 1A. FIG. 2 illustrates optional apparatuses 500A and 500B attached to the printing apparatus 1A. When the optional apparatuses 500A and 500B are apparatuses having the same configuration and are collectively referred to as the optional apparatuses 500A and 500B, or when no distinction need be made therebetween, the optional apparatuses 500A and 500B will simply be referred to as “optional apparatuses 500”. Each optional apparatus 500 includes a storage cassette 501 for storing a printing medium, and the addition of the optional apparatus 500 makes it possible to increase the storage capacity of the printing medium used for printing, to increase the types of the printing medium used for printing, and the like. The storage cassette 501 is removably attached to the body of the optional apparatus 500, and in the present embodiment, the storage cassette 501 is provided so as to be insertable into the body of the optional apparatus 500 from a front surface thereof, in the Y direction.

In the example illustrated in FIG. 2, two stages of optional apparatuses 500 are provided in a lower part of the printing apparatus 1A. However, it is also possible to attach only one optional apparatus 500 to the printing apparatus 1A, or three or more optional apparatuses 500 can be attached to the printing apparatus 1A. The printing apparatus 1A can also be used without the optional apparatus 500 attached thereto.

Although the present embodiment describes a case in which the present disclosure is applied in a serial ink jet printing apparatus, the present disclosure can also be applied in printing apparatuses that use other formats.

Note that “printing” includes not only forming information having meaning, such as text, graphics, and the like, but also broadly includes forming any image, pattern, or the like, which does or does not have meaning, on a printing medium or processing the medium, regardless of whether the content is manifested in a way that can be perceived visually by humans. In the present embodiment, sheet-shaped paper is assumed as the “printing medium”, but cloth, plastic film, or the like may be used instead.

In the drawings referred to in the present embodiment, arrows X, Y, and Z indicate directions intersecting with one another, where the arrows X and Y indicate horizontal directions orthogonal to each other, and the arrow Z indicates the vertical direction. The X direction corresponds to the left-right direction (the width direction) of the printing apparatus 1A, and the Y direction corresponds to the front-rear direction (the depth direction) of the printing apparatus 1A. The Z direction corresponds to the height direction of the printing apparatus 1A. When referring to the “downstream” side or the “upstream” side, the conveyance direction of the printing medium serves as a reference.

The printing apparatus 1A includes an apparatus body 100A, and a removable unit 640, a storage cassette 602A, and a tank unit 665 that can be attached to and removed from the apparatus body 100A. The apparatus body 100A includes a substantially cuboid-shaped housing 601, and the housing 601 forms outer walls of the printing apparatus 1A. The removable unit 640, the storage cassette 602A, and the tank unit 665 are inserted into a front surface 601a of the housing 601, which constitutes a front portion of the printing apparatus 1A, in the Y direction with respect to the apparatus body 100A. A cover 653 capable of opening and closing, which covers a feed unit 650 within the apparatus body 100A, is also provided on the front surface 601a. The cover 653, the removable unit 640, a storage unit 602A, and the tank unit 665 are arranged in this order from the top in the Z direction.

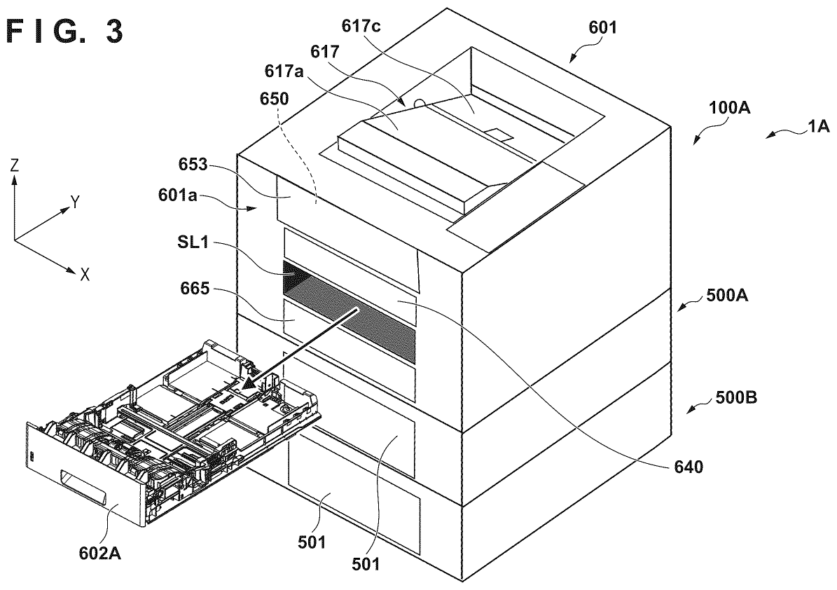

FIG. 3 is a diagram illustrating the state in which the storage cassette 602A is pulled out from the apparatus body 100A in a −Y direction. The apparatus body 100A includes a slot SL1 formed in the front surface 601a, and the storage cassette 602A is stored within the slot SL1.

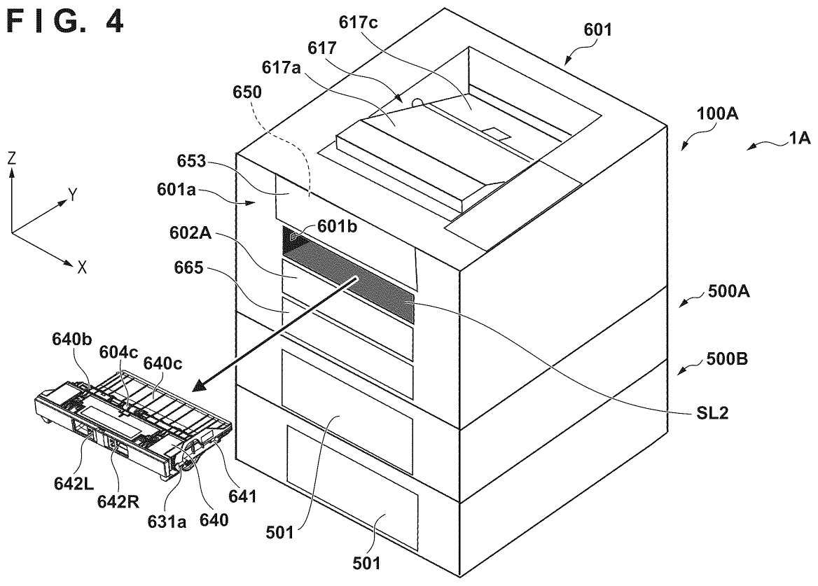

FIG. 4 is a diagram illustrating a state in which the removable unit 640 is removed from the apparatus body 100A in the −Y direction. The apparatus body 100A includes a slot SL2 formed in the front surface 601a, and the removable unit 640 is stored within the slot SL2.

Although not particularly indicated in the drawings, the tank unit 665 is also stored in a slot provided in the apparatus body 100A in the same manner as the storage cassette 602A and the removable unit 640.

A discharge tray 617 is provided in an upper surface part of the apparatus body 100A. The printing medium which has been printed onto is discharged to the discharge tray 617 and stacked on the discharge tray 617.

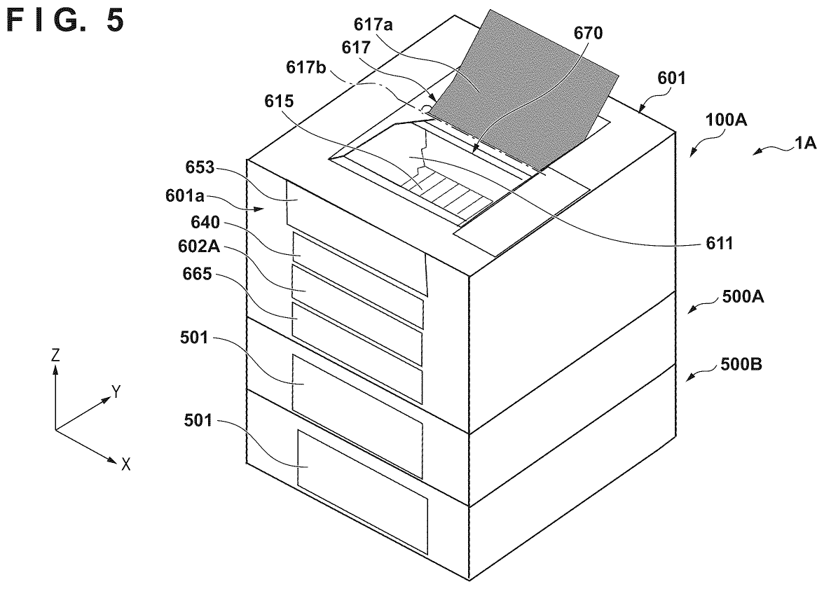

An opening part 670 formed in the upper surface part of the housing 601 to expose the interior of the apparatus body 100A of the printing apparatus 1A will be described with reference to FIGS. 2 and 5. The opening part 670 is opened and closed by an opening/closing member 617a. In the present embodiment, the opening/closing member 617a is a plate-shaped tray member constituting part of the discharge tray 617, and is a rotating member provided so as to be capable of rotating about a rotation center axis 617b in the X direction. FIG. 5 illustrates the opening/closing member 617a in an open state, and the opening part 670 in an open state. When the opening/closing member 617a is closed as illustrated in FIG. 2, the opening part 670 is closed.

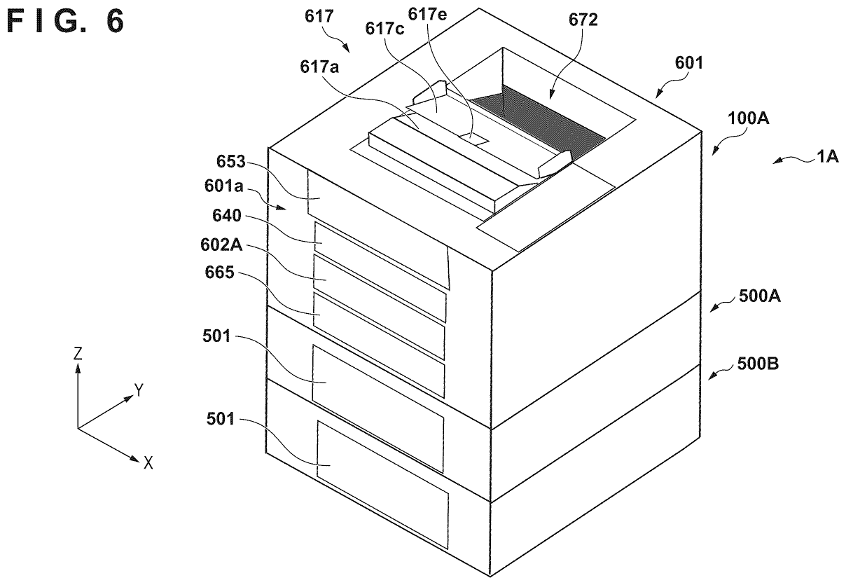

An opening part 672 formed in the upper surface part of the housing 601 to expose the interior of the apparatus body 100A of the printing apparatus 1A will be described with reference to FIGS. 2 and 6. The opening part 672 is located further toward the rear in the Y direction than the opening part 670. The opening part 672 is opened and closed by an opening/closing member 617c. In the present embodiment, the opening/closing member 617c is a plate-shaped tray member constituting part of the discharge tray 617 together with the opening/closing member 617a, and is configured to be pulled out to the front. When pulling out the opening/closing member 617c, a worker can perform the operation by holding a grip part 617e. FIG. 6 illustrates the opening/closing member 617c in an open state, and the opening part 672 in an open state. When the opening/closing member 617c is closed as illustrated in FIG. 2, the opening part 672 is closed.

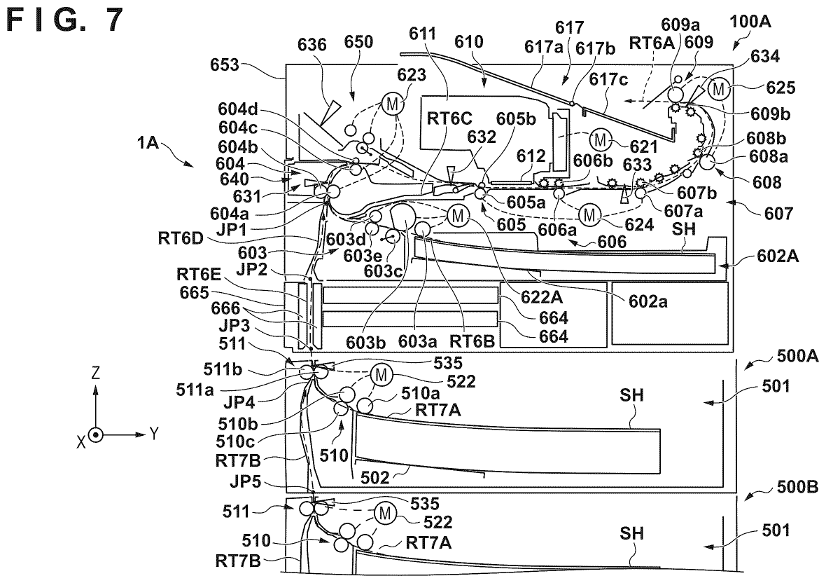

FIG. 7 is a schematic diagram illustrating the internal structures of the printing apparatus 1A and the optional apparatus 500. The printing apparatus 1A prints onto a sheet SH that is an unprinted printing medium loaded in a feed tray 602a within the storage cassette 602A. The printing apparatus 1A also discharges printed sheets SH to the discharge tray 617. The storage cassette 602A can be removed from the apparatus body 100A of the printing apparatus 1A, and the sheet SH can be set in the feed tray 602a of the removed storage cassette 602A.

The printing apparatus 1A also prints onto a sheet SH that is an unprinted printing medium loaded in a feed tray 502 within each optional apparatus 500. The printing apparatus 1A also discharges printed sheets SH to the discharge tray 617. The storage cassette 501 of the optional apparatus 500 can be removed from the optional apparatus 500, and the sheet SH can be set in the feed tray 502 of the removed storage cassette 501.

### Conveyance Paths

The conveyance paths of the sheet SH will be described here. The printing apparatus 1A includes conveyance paths RT6A to RT6E that guide the conveyance of the sheet SH. The conveyance path RT6A is a main conveyance path formed from a junction point JP1 to the discharge tray 617. The conveyance path RT6B is formed from the feed tray 602a to the junction point JP1. When printing onto the sheet SH stored in the storage cassette 602A, the sheet SH is conveyed in the order of (1) the conveyance path RT6B and (2) the conveyance path RT6A, and the printing is performed as the sheet SH is being conveyed.

The conveyance paths RT6D and RT6E are conveyance paths for feeding the sheet SH from the optional apparatus 500. The conveyance path RT6D is formed in the Z direction at a front part of the storage cassette 602A. Attaching the storage cassette 602A to the apparatus body 100A forms the conveyance path RT6D from an intermediate point JP2 to the junction point JP1. The conveyance path RT6E is formed in the Z direction at a front part of the tank unit 665. Attaching the tank unit 665 to the apparatus body 100A forms the conveyance path RT6E from an intermediate point JP3 to the intermediate point JP2.

Each optional apparatus 500 includes conveyance paths RT7A and RT7B that guide the conveyance of the sheet SH. The conveyance path RT7A is formed from the feed tray 502 to a junction point JP4 in the storage cassette 501, and is a conveyance path for feeding the sheet SH within the optional apparatus 500. The conveyance path RT7B is formed at a front part of the storage cassette 501, from an intermediate point JP5 to the junction point JP4. The conveyance path RT7B is a conveyance path for passing a sheet SH fed from another optional apparatus 500 located below the optional apparatus 500. For example, in the example illustrated in FIG. 7, the conveyance path RT7B of the optional apparatus 500A is a path for passing a sheet SH fed from the optional apparatus 500B through the optional apparatus 500A.

When printing onto the sheet SH stored in the optional apparatus 500A, the sheet SH is conveyed in the order of (1) the conveyance path RT7A of the optional apparatus 500A, (2) the conveyance path RT6E of the printing apparatus 1A, (3) a conveyance path 6D, and (4) the conveyance path RT6A, and the printing is performed as the sheet SH is being conveyed.

When printing onto a sheet SH stored in the optional apparatus 500B, the sheet SH is conveyed in the order of (1) the conveyance path RT7A of the optional apparatus 500B, (2) the conveyance path RT7B of the optional apparatus 500A, (3) the conveyance path RT6E of the printing apparatus 1A, (4) the conveyance path 6D, and (5) the conveyance path RT6A, and the printing is performed during the conveyance.

A path for reversing the front and back of the sheet SH and conveying the sheet SH to a print head 612 for the purpose of double-sided printing will be described next. In the present embodiment, the front and back of the sheet SH can be reversed by conveying the sheet SH to the conveyance path RT6C after printing on a first surface of the sheet SH using the print head 612. The conveyance path RT6C is an auxiliary conveyance path formed from the vicinity of a conveyance unit 605 (described later) to the junction point JP1. The front and back of the sheet SH for which the first surface has been printed onto can be reversed through the conveyance path RT6C, and then introduced into the conveyance path RT6A again. A second surface of the sheet SH can then be printed onto.

The introduction of the sheet SH into the conveyance path RT6C is performed as follows. After a trailing end of the sheet SH has reached the vicinity of the conveyance unit 605 (described later), or after the trailing end has exited the conveyance unit 605, at least some of the rollers of conveyance units 605 to 609 (described later) rotate in reverse. Through this, the sheet SH for which the first surface has been printed onto can be introduced into the conveyance path RT6C. The sheet SH for which the second surface has been printed onto is discharged to the discharge tray 617.

Note that each conveyance path is formed by path forming members. As an example of a path forming member, FIG. 7 schematically illustrates a pair of path forming members 666 forming the conveyance path RT6E. The pair of path forming members 666 are disposed so as to face the Y direction, and the conveyance path RT6E extending in the Z direction is formed therebetween. Each conveyance path is defined by such path forming members.

### Conveyance Mechanism

A configuration for conveying the sheet SH will be described next. The printing apparatus 1A includes a feed unit 603, a feed unit 604, and a plurality of conveyance units 605 to 609. The feed unit 603, the feed unit 604, and the conveyance units 605 to 609 are disposed in that order from the upstream side to the downstream side in the conveyance direction of the sheet SH, in the conveyance path RT6B and the conveyance path RT6A. An image is formed (printed) on the sheet SH at a printing unit 610 between the conveyance unit 605 and a conveyance unit 606.

### Feed Unit 603

The sheets SH in the feed tray 602a are introduced into the conveyance paths RT6B and RT6A one by one by the feed unit 603. The feed unit 603 is a pickup mechanism that uses a feed motor 622A as a drive source and picks up the sheets SH from the feed tray 602a. The feed unit 603 includes a feed roller (pickup roller) 603a, a feed roller 603b, a separation roller 603c, a feed roller 603d, and a driven roller 603e that forms a nip with the feed roller 603d.

The feed roller 603a contacts the uppermost surface of the sheets SH stacked in the feed tray 602a, rotates using the drive force of the feed motor 622A, and starts feeding the sheet SH. The feed roller 603b that rotates using a drive force of the feed motor 622A, and the separation roller 603c that forms a nip with the feed roller 603b, are disposed downstream from the feed roller 603a. The separation roller 603c is a roller which includes a torque limiter, and has rotational resistance. When two or more sheets SH enter the nip between the feed roller 603b and the separation roller 603c, the sheets SH are separated into single sheets due to the rotational resistance of the separation roller 603c.

The separated sheet SH is conveyed to the feed roller 603d and the driven roller 603e downstream. The feed roller 603d uses the feed motor 622A as a drive source.

### Feed Unit 604

The feed unit 604 conveys the sheet SH introduced into the conveyance path RT6A from the junction point JP1 to the conveyance unit 605. The feed unit 604 includes feed rollers 604a and 604c. The feed rollers 604a and 604c are rotating members that rotate under drive force from a feed motor 623. The feed rollers 604a and 604c are pressed against corresponding driven rollers 604b and 604d to form nips. The driven rollers 604b and 604d are rotating members that are rotated by the rotation of the feed rollers 604a and 604c.

The sheet SH is nipped at the nip between the feed roller 604a and the driven roller 604b, and the nip between the feed roller 604c and the driven roller 604d, and is conveyed by the rotation thereof.

Note that the feed rollers 603a, 603b, and 603d are one-way rollers. As such, after the leading end of the sheet SH has been conveyed to a position beyond the nip of the feed roller 604a, the feed unit 604 can continue to convey the sheet SH even after the driving of the feed unit 603 stops.

A sensor 631 is a sensor that senses the sheet SH, and senses the passage of the leading end and the trailing end of the sheet SH. A sensing position of the sensor 631 is set to a position downstream from the nip of the feed roller 604a. After detecting the passage of the leading end of the sheet SH, a sensing result from the sensor 631 can be used as a trigger for conveyance control, such as stopping the driving of the feed unit 603 or increasing the conveyance speed of the feed unit 604.

It is also possible to sense the size of the sheet SH detected on the basis of an amount of driving by the feed motor 623 and a motor 624 from when the leading end of the sheet SH is sensed by the sensor 631 to when the trailing end of the sheet SH is sensed, and then switch the subsequent conveyance control.

### Conveyance Unit 605

The conveyance unit 605 is disposed upstream from the print head 612. The sheet SH is conveyed downstream by the conveyance unit 605 between the print head 612 and a platen 615 opposite the print head 612. The conveyance unit 605 includes a conveyance roller 605a and a driven roller (a pinch roller) 605b that is pressed against the conveyance roller 605a by a spring or the like (not shown). The conveyance roller 605a is a rotating member rotated by drive force from a conveyance motor 624, and the driven roller 605b is a rotating member rotated by the rotation of the conveyance roller 605a. The sheet SH is nipped at a nip between the conveyance roller 605a and the driven roller 605b, and is conveyed by the rotation of the conveyance roller 605a and the driven roller 605b.

A sensor 632 is a sensor, such as an optical sensor, that, like the sensor 631, senses the sheet SH, and senses the passage of the leading end and the trailing end of the sheet SH. The sensor 632 is disposed in the vicinity of the conveyance unit 605 on the upstream side thereof, and thus a sensing result can be used to manage a loop amount for registering the sheet SH, the positions of the leading end and the trailing end of the sheet SH, and the like.

### Conveyance Unit 606

The conveyance unit 606 is disposed downstream from the print head 612, and conveys the sheet SH conveyed by the conveyance unit 605 to a conveyance unit 609 on the downstream side. The conveyance unit 606 includes a conveyance roller 606a and a spur 606b that is pressed against the conveyance roller 606a by a spring or the like (not shown). The conveyance roller 606a is a rotating member rotated by drive force from a conveyance motor 624, and the spur 606b is a rotating member rotated by the rotation of the conveyance roller 606a. In the present embodiment, the conveyance unit 605 and the conveyance unit 606 share a drive source (the conveyance motor 624).

### Conveyance Unit 607

A conveyance unit 607 is disposed downstream from the print head 612 and the conveyance unit 606, and conveys the sheet SH conveyed by the conveyance unit 606 to the downstream side. The conveyance unit 607 includes a conveyance roller 607a and a spur 607b that is pressed against the conveyance roller 607a by a spring or the like (not shown). The conveyance roller 607a is also a rotating member rotated by the drive force of the aforementioned conveyance motor 624, and the spur 607b is a rotating member rotated by the rotation of the conveyance roller 607a. The sheet SH is nipped at a nip between the conveyance roller 607a and the spur 607b, and is conveyed by the rotation of the conveyance roller 607a and the spur 607b.

Like the sensors 631 and 632, a sensor 633 is an optical sensor, for example, and senses the sheet SH. The sensor 633 can also be used to sense the leading end and the trailing end of the sheet SH, or to detect the presence or absence of the sheet SH in the conveyance path when a jam or the like of the sheet SH occurs in the conveyance path.

### Conveyance Units 608 and 609

Conveyance units 608 and 609 are located downstream from the print head 612 and the conveyance units 606 and 607. The conveyance units 608 and 609 are discharge units that discharge the sheet SH conveyed by the conveyance unit 607 to the discharge tray 617. In the case of single-sided printing, the sheet SH discharged to the discharge tray 617 with the surface thereof on which an image is printed facing downward, i.e., what is known as “face-down discharge”. In the case of double-sided printing, the second surface faces down.

The conveyance unit 608 includes a conveyance roller 608a and a spur 608b that is pressed against the conveyance roller 608a by a spring or the like (not shown). The conveyance roller 608a is a rotating member rotated by drive force from a conveyance motor 625, and the spur 608b is a rotating member rotated by the rotation of the conveyance roller 608a. The sheet SH is nipped at a nip between the conveyance roller 608a and the spur 608b, and is conveyed by the rotation of the conveyance roller 608a and the spur 608b.

The conveyance unit 609 includes a conveyance roller 609a and a spur 609b that is pressed against the conveyance roller 609a by a spring or the like (not shown). The conveyance roller 609a is a rotating member rotated by drive force from the same conveyance motor 625 as the aforementioned conveyance unit 608, and the spur 609b is a rotating member rotated by the rotation of the conveyance roller 609a. The sheet SH is nipped at a nip between the conveyance roller 609a and the spur 609b, and is conveyed by the rotation of the conveyance roller 609a and the spur 609b.

In the present embodiment, the conveyance unit 608 and the conveyance unit 609 share a drive source (the conveyance motor 625). However, the motor 625 may be omitted, and the conveyance motor 624, which is the drive source of the conveyance units 605 to 607, may also be shared with the conveyance unit 608 and the conveyance unit 609.

Additionally, in the present embodiment, four conveyance units (the conveyance units 606 to 609) are used on the downstream side of the print head 612, but the number of conveyance units can be reduced in accordance with the size, in the conveyance direction, of the printing medium which the printing apparatus 1A is capable of handling. For example, the configuration may be such that only the conveyance unit 606 and the conveyance unit 609 are used as conveyance units, and the sheet SH is discharged to the discharge tray 617 using the conveyance unit 609.

A sensor 634 is a sensor, such as an optical sensor, that, like the sensors 631 to 633, senses the sheet SH, and senses the passage of the leading end and the trailing end of the sheet SH. In the present embodiment, the discharge is complete (the trailing end of the sheet SH reaches the discharge tray 617) once the sheet SH has been conveyed by a predetermined amount after the sensor 634 senses the trailing end of the sheet SH. Accordingly, the sensing result from the sensor 634 can be used to detect the discharge of the sheet SH.

A mechanism for conveying the sheet SH, provided in the optional apparatus 500, will be described next. The sheet SH set in the feed tray 502 is separated one by one by a feed unit 510 in the optional apparatus 500, and fed to the conveyance path RT7A. The feed unit 510 is a pickup mechanism that uses a feed motor 522 as a drive source and picks up the sheets SH from the feed tray 502. The feed unit 510 includes a feed roller (pickup roller) 510a, a feed roller 510b, and a separation roller 510c.

A feed unit 511 is located downstream from the feed unit 510, and includes a feed roller 511a and a driven roller 511b. The feed roller 511a is a rotating member rotated by drive force from the feed motor 522, and the driven roller 511b is a rotating member rotated by the rotation of the feed roller 511a.

The sheet SH is nipped at a nip between the feed roller 511a and the driven roller 511b, and is conveyed by the rotation of the feed roller 511a and the driven roller 511b.

The sheet SH conveyed by the feed unit 511 of the optional apparatus 500A enters the conveyance path RT6E through a top surface-side outlet of the optional apparatus 500A and the intermediate point JP3, which is a conveyance path inlet at a bottom surface of the printing apparatus 1A. The sheet SH is further conveyed through the conveyance path RT6D to the junction point JP1.

The sheet SH conveyed by the feed unit 511 of the optional apparatus 500B enters the conveyance path RT7B through a top surface-side outlet of the optional apparatus 500B and the intermediate point JP5, which is a conveyance path inlet at a bottom surface of the optional apparatus 500A. The sheet SH further passes through the conveyance path RT7B of the optional apparatus 500A, and is conveyed to the junction point JP1 through the conveyance path RT6D by the feed unit 511 of the optional apparatus 500A.

### Printing Unit

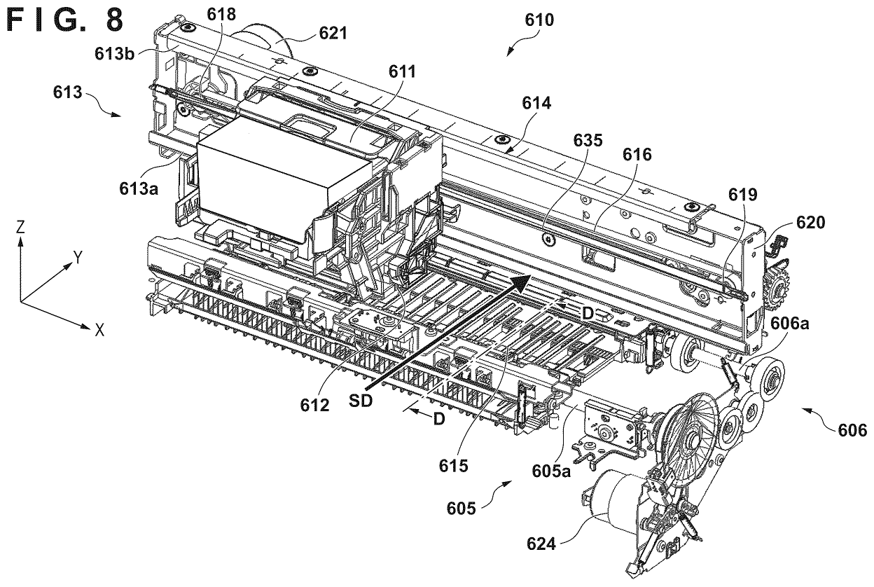

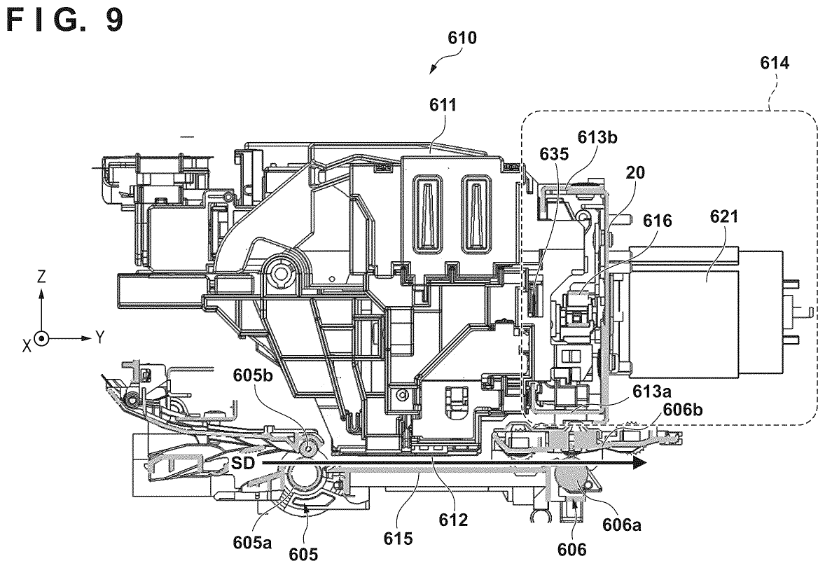

The printing unit 610 according to the present embodiment will be described with reference to FIGS. 8 and 9, in addition to FIG. 7. FIG. 8 is a perspective view of the printing unit 610, and FIG. 9 is a cross-sectional view taken along line D-D in FIG. 8. The printing unit 610 includes the print head 612, a carriage 611, and a drive unit 614. The print head 612 ejects liquid ink onto the sheet SH to print an image on the sheet SH. A lower surface of the print head 612 forms an ejection surface in which a plurality of nozzles for ejecting ink are formed.

The ink supplied to the print head 612 is held within an ink tank 664 of the tank unit 665. The ink held in the ink tank 664 is supplied to the print head 612 through a tube (not shown) (a tube supply method). Note that ink supply methods include an independent ink cartridge method in which the ink cartridge is mounted on the carriage 611 with the print head 612, a head cartridge method in which the ink cartridge and the print head 612 are integrated, and the like, and either of these may be used.

The platen 615 is disposed opposite the print head 612 (and particularly, the ejection surface thereof) between the conveyance unit 605 and the conveyance unit 606. The sheet SH is conveyed in the direction of an arrow SD (the +Y direction) between the print head 612 and the platen 615, and an image is printed thereon by the print head 612. The print head 612 is mounted on the carriage 611. The carriage 611 is moved back and forth by the drive unit 614 in a direction intersecting with the SD direction (the X-axis direction, in the present embodiment).

The drive unit 614 includes a support member 620 extending in the X-axis direction. The support member 620 is a base member that supports each component of the drive unit 614. The support member 620 is provided with a guide member 613 that engages with the carriage 611 and guides the movement of the carriage 611. In the present embodiment, the guide member 613 includes a lower rail member 613a and an upper rail member 613b. The rail members 613a and 613b are separated from each other in the Z-axis direction, and each is provided extending in the X-axis direction. The rail members 613a and 613b engage with the carriage 611 and guide the movement of the carriage 611. Note that the guide member 613 may be a shaft-shaped member.

The rail member 613a supports the carriage 611 in the height (Z) direction and the front-rear (Y) direction. By adjusting the height (Z) of the rail member 613a relative to the support member 620, the height (Z position) of the print head 612 (and particularly the ejection surface thereof) relative to the platen 615 can be adjusted. The rail member 613b is positioned above the rail member 613a (the +Z direction), and regulates the position of the carriage 611 about the X axis. By adjusting the rail member 613b in the front-rear (Y) direction relative to the support member 620, the tilt of the print head 612 about the X axis relative to the platen 615 can be adjusted.

The drive unit 614 of the present embodiment is a belt drive mechanism using a carriage motor 621 as a drive source. However, the mechanism of the drive unit 614 may have a different form than a belt drive mechanism. The carriage motor 621 is disposed opposite from the carriage 611 with the support member 620 therebetween, in the front-rear (Y) direction. The drive unit 614 includes a drive pulley 618 and a driven pulley 619 that are distanced from each other in the X-axis direction, as well as an endless belt 616 wrapped around the pulleys, and these members are disposed between the rail member 613a and the rail member 613b in the height (Z) direction.

The carriage 611 is fixed to the endless belt 616. When the carriage motor 621 rotates the drive pulley 618, the endless belt 616 travels and the carriage 611 moves. A cord strip 635 is supported by the support member 620. A sensor (not shown) that senses slits in the cord strip 635 is provided in the carriage 611, and on the basis of a sensing result from the sensor, the position of the carriage 611 in the X-axis direction can be determined, the speed can be adjusted, and the like.

An electrical contact between the print head 612 and a board (not shown) is provided in the carriage 611. The board (not shown) may be disposed downstream from the print head 612 in the conveyance direction (the +Y direction) and between the carriage 611 and the support member 620.

Operations for printing an image will be described next. An image is printed by ejecting ink from the print head 612 onto the sheet SH as the carriage 611 moves back and forth in the X-axis direction. This operation is called a “print scan”. Printing operations are performed by alternately repeating a conveyance operation, in which the sheet SH is conveyed intermittently in the SD direction (the +Y direction) by the conveyance unit 605, and a print scan.

### Front Surface Feed Mechanism

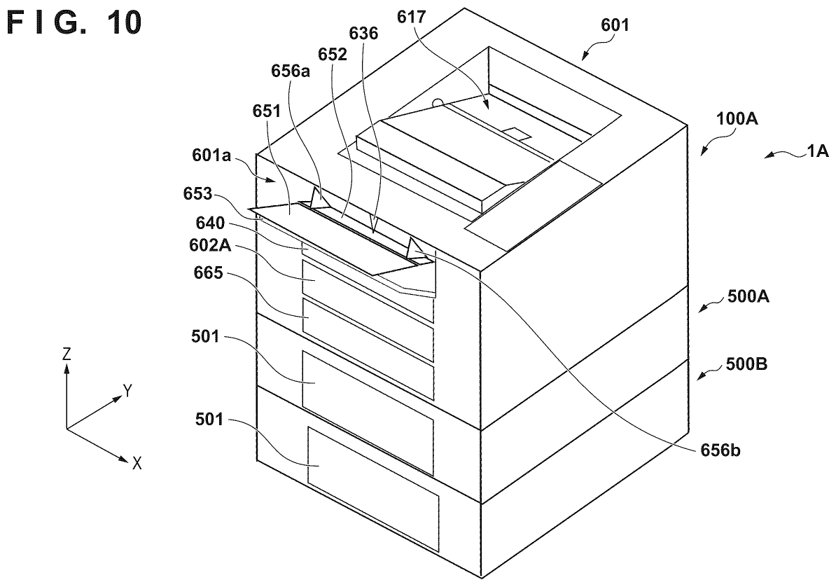

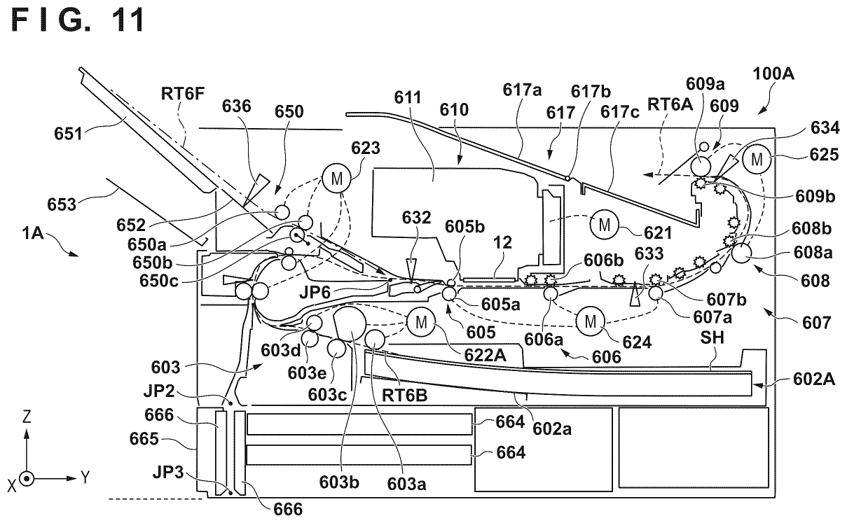

A front surface feed mechanism of the printing apparatus 1A will be described with reference to FIGS. 10 and 11. The sheet SH can be supplied manually from the front side of the printing apparatus 1A using the front surface feed mechanism. FIG. 10 is a diagram illustrating a state in which the cover 653 and a feed tray 651 are pulled out, from the state illustrated in FIG. 2. FIG. 11 is a schematic diagram illustrating the internal structure of the printing apparatus 1A, with the cover 653 and the feed tray 651 pulled out.

In the present embodiment, in addition to the storage cassette 602A described earlier, the feed unit 650 is disposed above the storage cassette 602A and the removable unit 640 in the Z direction (the +Z direction) and on the front surface 601a side of the printing apparatus 1A. FIG. 2 illustrates a state in which a stacking tray 651 is closed, and FIG. 10 illustrates a state in which the stacking tray 651 is open. When the stacking tray 651 is closed, a plurality of trays are folded and stored therein. When the stacking tray 651 is opened, the plurality of trays that had been folded extend to a length at which sheets SH stacked thereon can be held without falling.

A feed tray 652 is provided at the back of the open stacking tray 651, and the feed tray 652 holds the sheets SH stacked on both the stacking tray 651 and the feed tray 652. The feed tray 652 includes a sensor 636 that senses whether a sheet SH is stacked thereon.

The sensor 636 is a sensor that senses the sheet SH, and is an optical sensor, for example. The sensor 636 detects the presence or absence of a sheet SH on the feed tray 652, and can be configured using a reflective sensor or the like, for example. In addition, side guides 656a and 656b for supporting the stacked sheets SH in the width direction are attached to the left and right sides of the feed tray 652. The left and right side guides 656a and 656b are connected by a rack and pinion (not shown). When a user operates one of the side guides, the other side guide can move in tandem therewith, and the left and right ends of the sheet SH can be supported.

The arrangement of the feed unit 650 and a conveyance path RT6F will be described next. The feed unit 650 includes a feed roller 650a that is pressed against a sheet SH stacked on the feed tray 652. A conveyance roller 650b and a separation roller 650c are provided downstream from the feed roller 650a. The feed roller 650a and the conveyance roller 650b are driven using the feed motor 623 as a drive source. The sheets SH set in the feed tray 652 are picked up by the feed roller 650a, separated into a single sheet SH at a nip between the conveyance roller 650b and the separation roller 650c, and fed to the conveyance path RT6A. The sheet SH fed from the feed unit 650 joins the conveyance path RT6A at a junction point JP6, and is conveyed to the conveyance unit 605. An image is then printed onto the sheet SH by the print head 612 while the sheet SH is being conveyed by the conveyance unit 605.

### Layout of Configuration Around Print Head

Refer to FIGS. 8 and 9. The sheets SH may jam around the print head 612. The drive unit 614 is a structure including the support member 620, which is fixed in the form of a wall in the X-Z plane. Depending on the arrangement of the drive unit 614 of the carriage 611, the drive unit 614 can easily become an obstruction inhibiting the ability of a worker to access the location where jams occur.

In the present embodiment, the drive unit 614 is disposed downstream (the +Y direction) from the print head 612 in the conveyance direction (the SD direction). A large space is present on the upstream side of the print head 612, which makes it easier for the worker to access the upstream side of the print head 612. Jams often occur when the leading end of the sheet SH jams between the print head 612 and the platen 615, and thus the worker can easily work from the upstream side of the print head 62, which makes the task of eliminating the jam proceed more smoothly.

Looking in the front-rear direction of the printing apparatus 1A (the Y direction), the conveyance unit 605 is disposed on the front side (the −Y direction side) relative to the print head 612, and the drive unit 614 is disposed on the rear side (the +Y direction side) relative to the print head 612. In places where the printing apparatus 1A is installed, it is often the case that a large space is available in front of the printing apparatus 1A, but a wall or the like is present behind the printing apparatus 1A. In the present embodiment, the space in front of the print head 612 is larger, and thus when a jam occurs, it is easy for the worker to perform the task for clearing the jam from the front side of the printing apparatus 1A.

Additionally, in the present embodiment, the feed unit 604 is disposed further toward the front than the conveyance unit 605. Even when a jam occurs between the feed unit 604 and the conveyance unit 605, it is easy for the worker to perform the task for clearing the jam from the front surface 601a of the printing apparatus 1A.

### Structures Related to Maintenance

### Maintenance Around Print Head

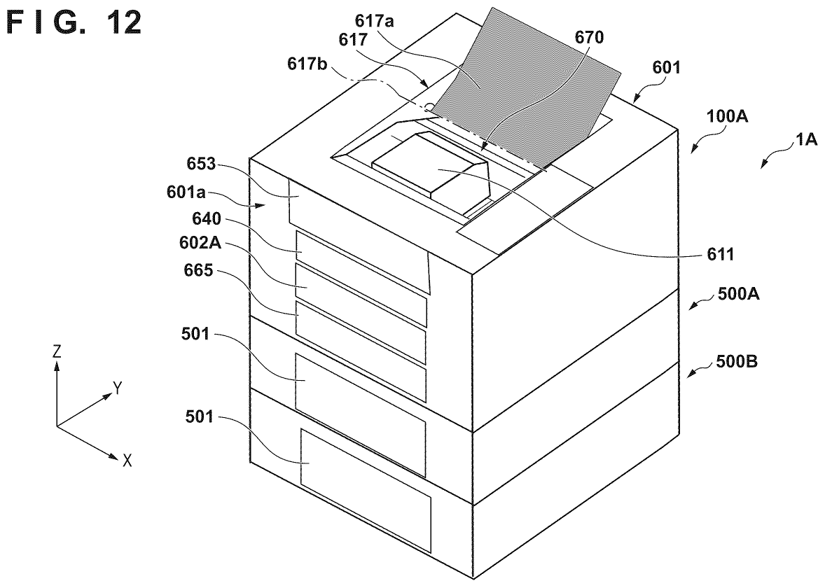

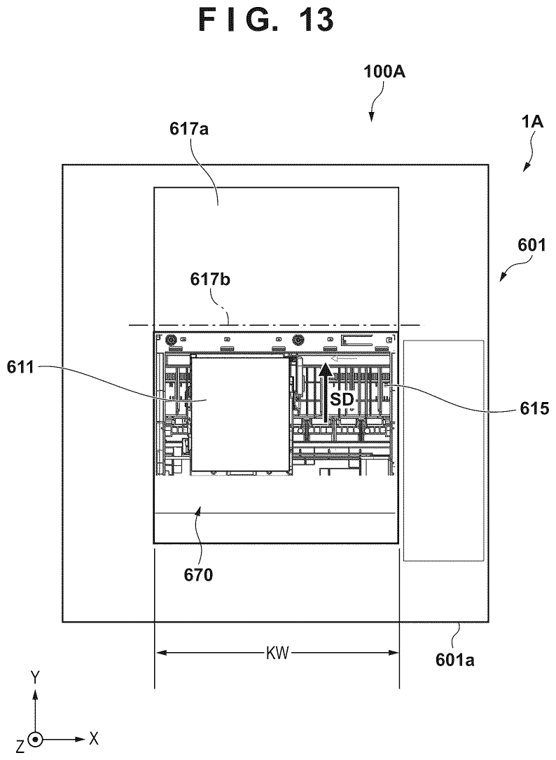

The printing apparatus 1A according to the present embodiment includes a structure that facilitates maintenance of (access to) the printing unit 610. This will be described with reference to FIGS. 5, 6, 12, and 13. FIG. 12 is an exterior view of the printing apparatus 1A in which the opening/closing member 617a is open, and FIG. 13 is a plan view of the printing apparatus 1A in which the opening/closing member 617a is open.

Clearing a jam as described above, replacing the print head 612, and the like can be given as examples of maintenance performed on the printing unit 610.

The opening part 670 is formed such that a part upstream from the print head 612 in the conveyance direction (the SD direction) (i.e., on the −Y direction side) is exposed more than a part on the downstream side (the +Y direction side). The opening/closing member 617a is disposed above the conveyance unit 605 (the +Z direction). When the opening/closing member 617a is open, the conveyance unit 605, the carriage 611, the print head 612, the platen 615, and the like are exposed through the opening part 670, and can therefore be accessed by the worker. In the present embodiment, the drive unit 614 is disposed downstream from the print head 612 in the conveyance direction (the +Y direction side), and it is therefore easy to access the conveyance unit 605, the carriage 611, the print head 612, the platen 615, and the like from the front side of the printing apparatus 1A.

As illustrated in FIG. 13, if the width of the opening part 670 in the X direction is represented by KW, the width KW is greater than a maximum width of the sizes of the sheet SH that can be handled by the printing apparatus 1A. Accordingly, when the sheet SH has jammed, the sheet SH can be removed from the opening part 670 with case.

### Configuration of Apparatus Body 100A

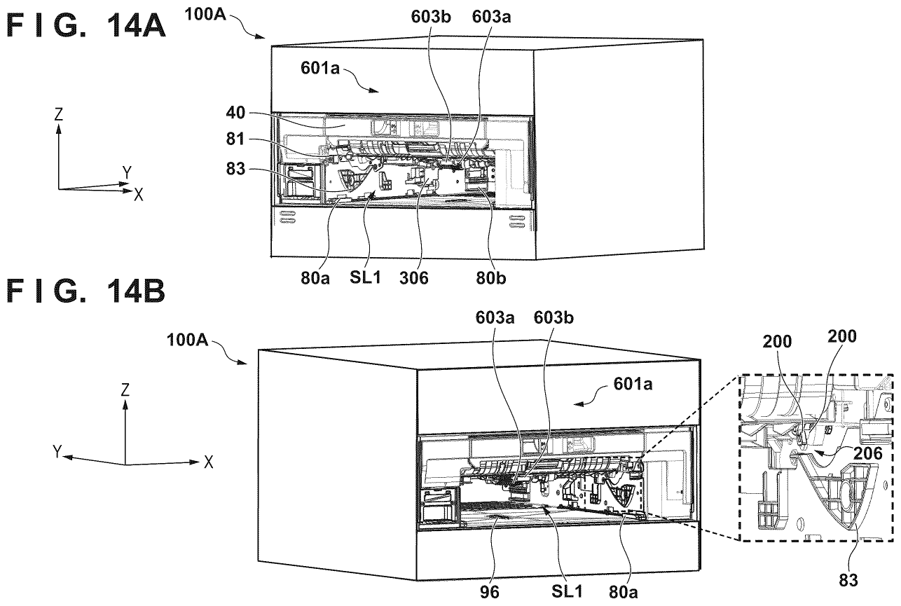

The configuration of the apparatus body 100A will be described further with reference to FIGS. 14A and 14B. In other words, the configuration of the housing 601 will be described. FIGS. 14A and 14B are enlarged views illustrating part of the internal structure of the printing apparatus 1A when the storage cassette 602A is removed from the apparatus body 100A. In addition, FIGS. 14A and 14B correspond to perspective views of the periphery of the slot SL1 of the apparatus body 100A from different angles. Note that the following descriptions may refer to removing and attaching the storage cassette 602A from and to the housing 601 as removing and attaching the storage cassette 602A from and to the apparatus body 100A.

The apparatus body 100A includes rails 80a to 80b that support the storage cassette 602A in the Y direction, in a removable state, and guide the movement of the storage cassette 602A within the slot SL1. Note that the rails 80a to 80b are provided on respective sides of the slot SL1 in the X direction.

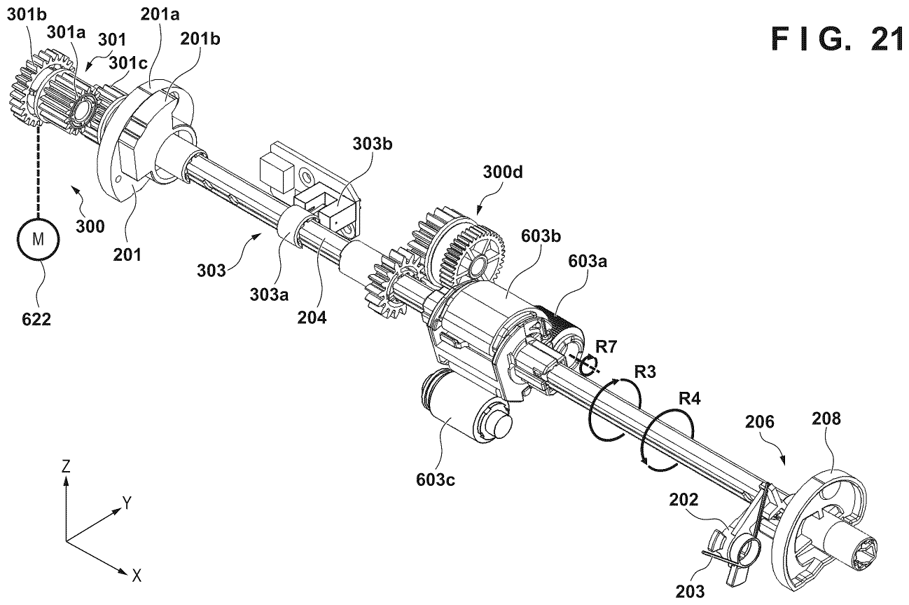

As described above, the apparatus body 100A includes the feed roller 603a, and a feed roller 602b. The feed roller 603a and the feed roller 603b are provided on an upper wall of the slot SL1. The feed roller 603a is a pickup roller that is disposed upstream from the feed roller 603b in the feed direction of the sheet SH, and that feeds the uppermost sheet SH held in the storage cassette 602A to the feed roller 603b (see FIG. 7). The feed roller 603a can smoothly feed the sheet SH within the storage cassette 602A to the feed roller 603b on the downstream side. The configuration around the feed roller 602b will be described in detail later with reference to FIG. 21.

The apparatus body 100A includes a regulating unit 206 that regulates the rotation of the feed roller 603b in conjunction with the removal of the storage cassette 602A from the apparatus body 100A. The regulating unit 206 is supported by a support member 200 provided on a side wall of the slot SL1. A rotational regulation action by the regulating unit 206 will be described in detail later.

The apparatus body 100A includes a pressure plate cam 83 and a pressure plate release lever 96. The pressure plate cam 83 is provided on both side walls of the apparatus body 100A in the slot SL1. The pressure plate cam 83 depresses an end of a pressure plate 91 of the storage cassette 602A (described later) when the storage cassette 602A is removed from the apparatus body 100A. The pressure plate release lever 96 is provided in a bottom wall of the slot SL1, and releases the pressure plate 91 from being held by a pressure plate holding part when the storage cassette 602A is attached to the apparatus body 100A.

Note that FIGS. 14A and 14B illustrate a state in which the storage cassette 602A has been removed from the apparatus body 100A, as described above. When the storage cassette 602A is removed from the apparatus body 100A, the feed roller 603a and the feed roller 603b remaining on the apparatus body 100A side are exposed, and the worker can access the slot SL1. Through this, the worker can perform a task of replacing the feed roller 603a and the feed roller 603b, for example. Additionally, if a jam has occurred near the feed roller 603a and the feed roller 603b, for example, the worker can clear the jam more easily. In the present embodiment, the feed roller 603a and the feed roller 603b are configured to be separately removable. Note that the feed roller 603a and the feed roller 603b are not limited to a configuration in which the rollers can be removed separately, and the apparatus body 100A may be configured to support the feed roller 603a and the feed roller 603b with a single holder such that the rollers can be removed at the same time. Additionally, as illustrated in FIG. 3, the direction in which the storage cassette 602A is removed (pulled out) is to the front of the printing apparatus 1A (the front surface 601a side; the −Y direction side). The direction in which the feed roller 603a feeds the sheet SH is also to the front of the printing apparatus 1A (the front surface 601a side). Accordingly, by removing the storage cassette 602A, the worker can perform the tasks described above (clearing jams and replacing rollers) from the front surface 601a side of the printing apparatus 1A.

### Configuration of Storage Cassette

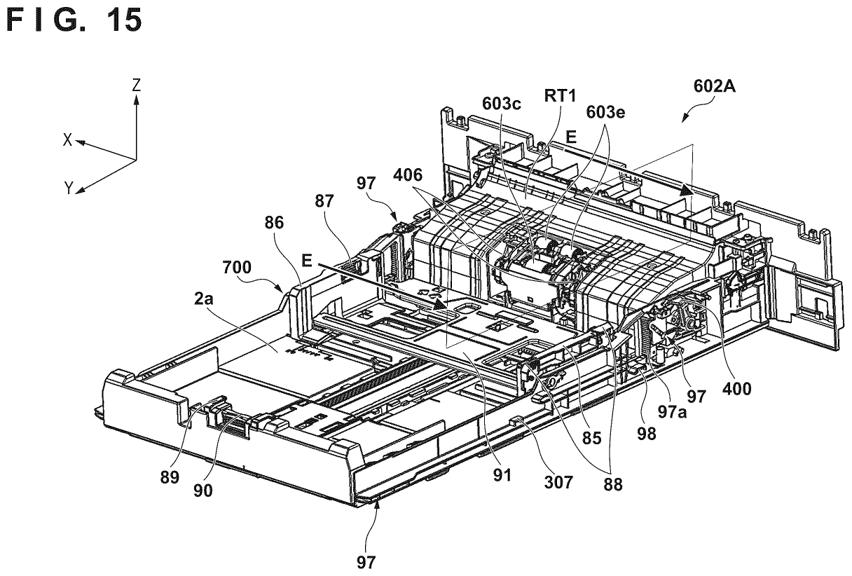

The configurations of parts of the storage cassette 602A will be described next. First, refer to FIG. 15. FIG. 15 is a perspective view illustrating the storage cassette 602A removed from the apparatus body 100A.

The storage cassette 602A includes a stacking part 700 in which the sheets SH are stacked. The stacking part 700 includes the feed tray 602a and the pressure plate 91. The stacking part 700 is provided in the storage cassette 602A so as to be capable of rising and falling. In addition, the storage cassette 602A includes side guides 85 and 86, which that align the sides of the stack of the sheets SH in accordance with the sheets SH stacked in the stacking part 700, and a side locking part 87. The side guides 85 and 86 are provided at both ends of the storage cassette 602A in the X direction, and regulate the positions of the sides of the stack of the sheets SH. The side locking part 87 is provided in the side guide 86, and prevents the position of the side guide 86 from shifting using a locking member such as a latch.

In addition, the storage cassette 602A includes an end guide 89, which aligns the back of the stack of the sheets SH in accordance with the sheets SH that are stored, and an end locking part 90. The end guide 89 is provided at the end of the storage cassette 602A in the Y direction, and regulates the position of the back of the stack of the sheets SH. The end locking part 90 is provided in the end guide 89, and prevents the position of the end guide 89 from shifting using a locking member such as a latch.

The side guide 85 is connected to the side guide 86 by a rack and pinion (not shown) under the pressure plate 91. Accordingly, when a user operates the side guide 86, the side guide 85 can operate at the same time, and the positions of the sides of the stack of the sheets SH can be regulated.

The storage cassette 602A also includes a side biasing plate 88 for biasing the side guide 85 in the X direction. The side biasing plate 88 is provided in the side guide 85, and is biased in the X direction by a spring (not shown). Sheets can be fed in a stable manner by the side biasing plate 88 supporting the side ends of the sheets SH.

The pressure plate 91 is provided in the storage cassette 602A so as to be capable of rising and falling in the stacking direction of the sheets SH. The pressure plate 91 is biased in the Z direction by a spring (not shown) installed below the pressure plate 91, and rises to a position where the stacked sheets SH are pressed against the feed roller 603a. As a result, the sheets SH stacked in the storage cassette 602A can be pressed against the feed roller 603a by the pressure plate 91 while the storage cassette 602A is attached to the apparatus body 100A.

The storage cassette 602A includes a pressure plate separation mechanism 97 for separating the pressure plate 91 from the feed roller 603a. The pressure plate separation mechanism 97 is, in other words, a mechanism for lowering the pressure plate 91. The pressure plate separation mechanism 97 is provided at both ends of the storage cassette 602A. The pressure plate separation mechanism 97 includes an engagement part 97a. The pressure plate 91 includes an engagement part 98 that engages with the engagement part 97a. The pressure plate 91 can be separated from the feed roller 603a by engaging the engagement part 97a of the pressure plate separation mechanism 97 with the engagement part 98 while the storage cassette 602A is attached to the apparatus body 100A. In other words, the spring that biases the pressure plate 91 and the pressure plate separation mechanism 97 can also be called a raising/lowering unit that raises and lowers the stacking part 700.

As described above, the apparatus body 100A includes the pressure plate cam 83 and the pressure plate release lever 96 (see FIGS. 14A and 14B). The two ends of the pressure plate 91 are depressed by the pressure plate cam 83 when the storage cassette 602A is removed from the apparatus body 100A. As a result, the pressure plate 91 is held by the pressure plate holding part (not shown) provided in the storage cassette 602A. FIG. 15 illustrates a state in which the storage cassette 602A is removed from the body 100A, and the pressure plate 91 is held by the pressure plate holding part (not shown).

When the storage cassette 602A is attached to the apparatus body 100A, the pressure plate 91 is released from being held by the pressure plate holding part by the action of the pressure plate release lever 96. As a result, the pressure plate 91 is biased by the spring (not shown) installed below the pressure plate 91, and rises to a feed position for the sheets SH (a position where the pressure plate 91 presses the sheets SH against the feed roller 603a).

The storage cassette 602A includes the separation roller 603c capable of contacting the feed roller 603b while the storage cassette 602A is attached to the apparatus body 100A, and the driven roller 603e that forms a nip with the feed roller 603d. The separation roller 603c is a roller which includes a torque limiter, and has rotational resistance, as described above. For example, when two or more sheets SH enter the nip between the feed roller 603b and the separation roller 603c, the sheets SH can be separated into single sheets due to the rotational resistance of the separation roller 603c. In other words, the separation roller 603c is a sheet separation unit for separating and feeding the sheets SH stored in the storage cassette 602A. Note that in the present embodiment, the mechanism for provided the separation roller 603c with rotational resistance is not limited to a torque limiter. Additionally, although the storage cassette 602A includes the separation roller 603c as the sheet separation unit that separates and feeds the sheets SH in the present embodiment, the configuration is not limited thereto. For example, the storage cassette 602A may be configured including a sheet separation unit such as a separation pad or the like.

Incidentally, the printing apparatus 1A conveys the sheet SH by rotating the feed roller 603b. For example, when the separation roller 603c is in constant contact with the feed roller 603b when conveying the sheet SH, the feed roller 603b is subjected to rotational resistance from the separation roller 603c. This increases the amount of power required for the printing apparatus 1A to convey the sheets SH. This also makes it more likely that the temperature of the feed motor 622A that drives the feed roller 603b will rise. Furthermore, in a configuration where the separation roller 603c is constantly pressed against the feed roller 603b when conveying the sheets SH, the rollers are prone to wear. A technique for reducing the conveyance resistance when conveying the sheet SH is therefore needed. In the present embodiment, as will be described later, the position of the separation roller 603c can be switched between a contact position where the separation roller 603c is in contact with the feed roller 603b, and a separated position where the separation roller 603c is separated from the feed roller 603b. Such a configuration makes it possible to reduce the conveyance resistance when conveying the sheets SH.

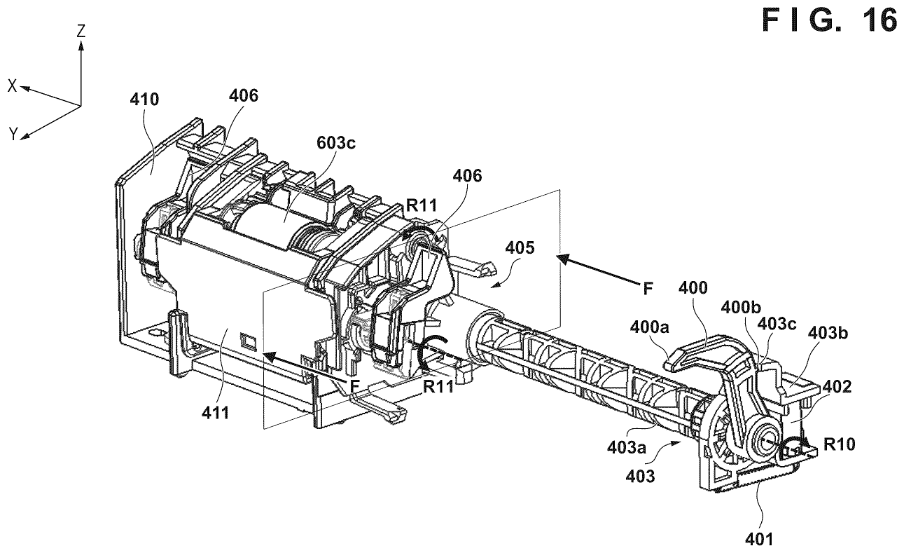

The configuration around the separation roller 603c will be described here. First, refer to FIG. 16. FIG. 16 is a schematic diagram illustrating part of the internal configuration of the storage cassette 602A. The storage cassette 602A includes a separation part support part 410, a sheet return part 406, a switching mechanism 405, a follower support member 403, a separation follower 400, a cover part 411, and the like.

The separation part support part 410 is supported by the storage cassette 602A. The separation part support part 410 supports the sheet return part 406, the cover part 411, and the switching mechanism 405, as well as a separation roller holder 95, a holder support part 496, and the like, which will be described later.

The sheet return part 406 is a claw-shaped member that returns the sheet SH separated by the separation roller 603c to the storage cassette 602A. The sheet return part 406 is supported by a rotating shaft 407 (described later). The sheet return part 406 can be switched to a projecting position, where the sheet return part 406 projects into the conveyance path of the sheets SH, and a retracted position, where the sheet return part 406 is retracted from the conveyance path, by rotating the rotating shaft 407 about a rotational center. In FIG. 16, the sheet return part 406 is positioned in the retracted position. In the projecting position, the sheet return part 406 returns the sheet SH separated by the separation roller 603c to the storage cassette 602A. Providing the sheet return part 406 in the storage cassette 602A in this manner makes it possible to prevent the sheets SH separated by the separation roller 603c from being fed in multiple by the feed roller 603b.

Note that while the storage cassette 602A is removed from the apparatus body 100A, the position of the sheet return part 406 is switched from the projecting position to the retracted position. Accordingly, when the sheets SH are set, the sheets SH and the like does not get caught in the sheet return part 406, which makes it possible to prevent the sheet return part 406 from being damaged.

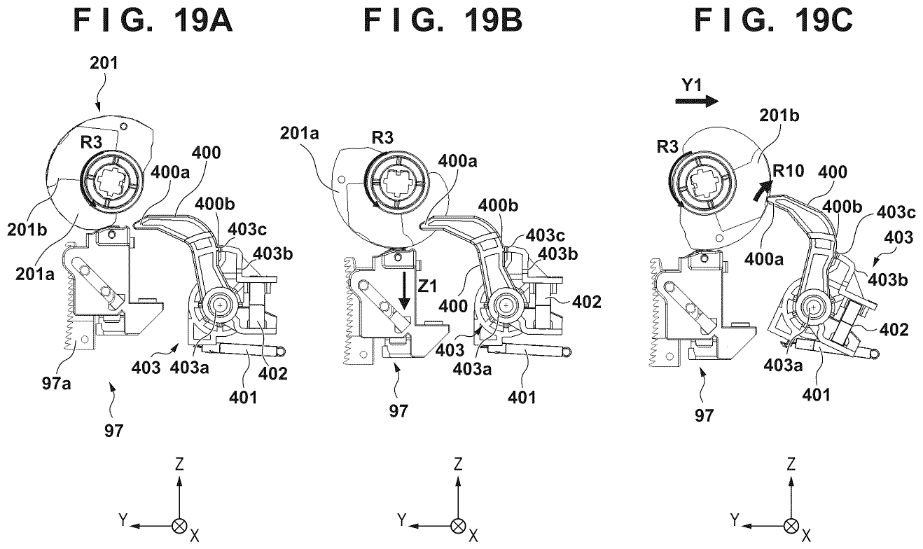

The separation follower 400 is rotatably supported by the follower support member 403. As will be described later, the separation follower 400 rotates along with a rotating L-side cam 201 while the storage cassette 602A is attached to the apparatus body 100A (see FIGS. 19A to 19C). The separation follower 400 includes a tip part 400a capable of contacting the L-side cam 201 (described later) while the storage cassette 602A is attached to the apparatus body 100A. The separation follower 400 is curved so as to project toward the downstream side of the attachment direction (the Y direction) when the storage cassette 602A is attached to the apparatus body 100A. The tip part 400a is a tip part having a curved shape.

The follower support member 403 (a rotating support member) is capable of rotating in a direction R10 and in the direction opposite from the direction R10. The follower support member 403 supports the separation follower 400 so as to be capable of rotating about the X axis. Specifically, the follower support member 403 includes a rotating shaft 403a and a support part 403b formed integrally with the rotating shaft 403a. The rotating shaft 403a is disposed parallel to the X direction within the storage cassette 602A, and is supported so as to be capable of rotating about the X axis by the storage cassette 602A and the separation part support part 410. The rotating shaft 403a supports the separation follower 400 so as to be capable of rotating about the X axis. The support part 403b includes a contact part 403c capable of contacting a contact part 400b of the separation follower 400 from the downstream side in the removal direction (the −Y direction) when the storage cassette 602A is removed.

The storage cassette 602A includes a follower shaft spring 401 that biases the follower support member 403 in the direction opposite from the direction R10. When the follower support member 403 is biased in the direction opposite from the direction R10 by the follower shaft spring 401, the support part 403b rotates in the direction opposite from the direction R10 while supporting the separation follower 400. Note that when the follower support member 403 is biased in the direction opposite from the direction R10 by the follower shaft spring 401, the support part 403b contacts the storage cassette 602A. In other words, the follower shaft spring 401 can be said to bias the follower support member 403 in the Y direction such that the contact part 403c contacts the separation follower 400. In addition, the follower shaft spring 401 can be said to bias the separation follower 400 such that the tip part 400a of the separation follower 400 moves in the Y direction opposite from the −Y direction. Through this, as will be described later, even if the separation follower 400 rotates along with the rotating L-side cam 201, the rotary attitude of the separation follower 400 can then be returned to the state illustrated in FIG. 16.

In addition, the storage cassette 602A includes a separation follower spring 402 that biases both the separation follower 400 and the follower support member 403. The separation follower spring 402 biases the separation follower 400 in the direction R10. In other words, the separation follower spring 402 biases the separation follower 400 such that the tip part 400a moves in the −Y direction. Through this, for example, when the storage cassette 602A is attached to the apparatus body 100A, even if the separation follower 400 rotates in the direction opposite from the direction R10, the rotary attitude of the separation follower 400 can be returned to the state illustrated in FIG. 16, as will be described later.

In addition, the separation follower spring 402 biases the follower support member 403 in the direction opposite from the direction R10. In this manner, the follower support member 403 and the separation follower 400 are biased, and the contact part 400b of the separation follower 400 and the contact part 403c of the follower support member 403 contact each other.

For example, if the separation follower 400 moves with the rotating L-side cam 201 and is subjected to a force in the direction R10, the follower support member 403 and the separation follower 400 rotate together in the direction R10. Additionally, as described above, the separation follower 400 is rotatably supported by the rotating shaft 403a of the follower support member 403. Accordingly, if the separation follower 400 is subjected to a force in the direction opposite from the direction R10, only the separation follower 400 rotates.

Note that when the storage cassette 602A is removed from the apparatus body 100A, the support part 403b is biased in the direction R10 by the separation follower shaft spring 401, and contacts the storage cassette 602A.

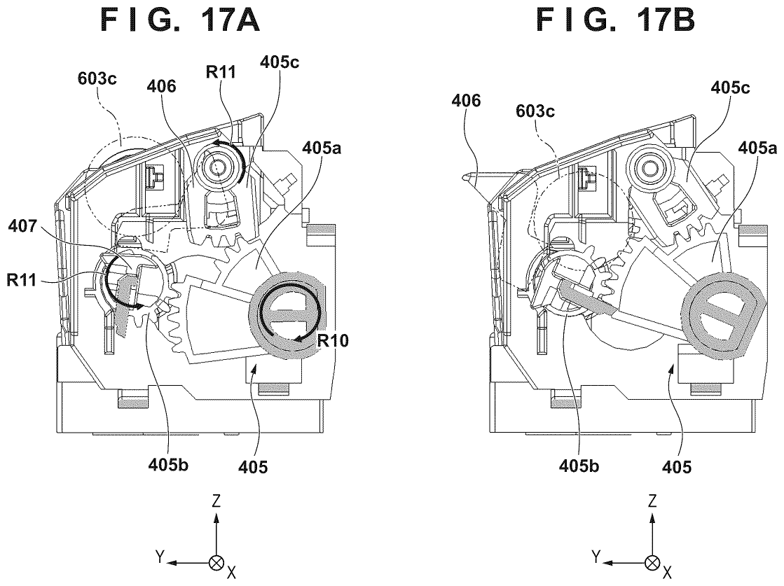

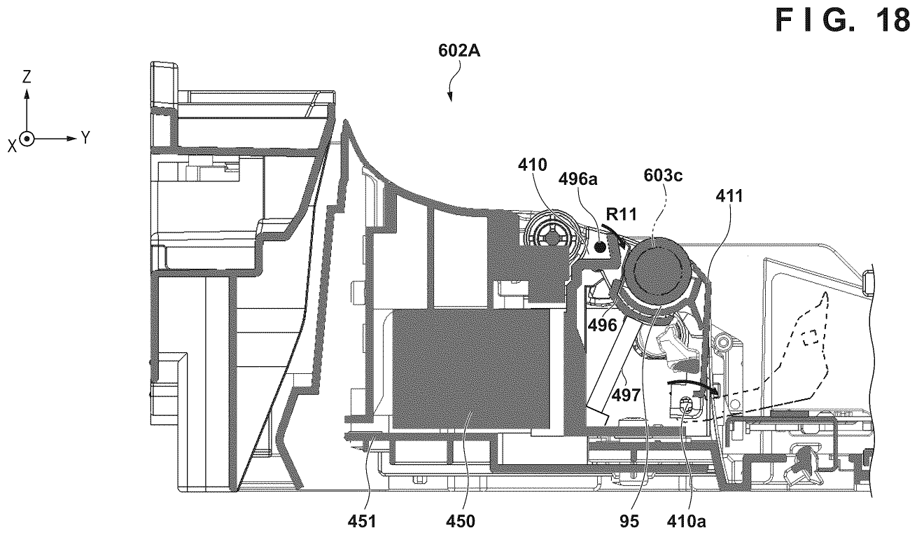

The configuration around the separation roller 603c will be described in further detail here with reference to FIGS. 17A to 18. First, refer to FIG. 18. FIG. 18 is a cross-sectional view along E-E in FIG. 15.

The storage cassette 602A includes the separation roller holder 95, the holder support part 496, a separation roller spring 497, the cover part 411, a support part 410a, and a sound absorbing material 450.

The separation roller holder 95 is a holder for supporting the rotating shaft of the separation roller 603c and supporting the rotation of the separation roller 603c. The holder support part 496 supports the separation roller holder 95 and the separation roller 603c. The holder support part 496 is supported by the separation part support part 410 so as to be capable of rotating about a rotational center 496a.

The separation roller spring 497 biases the holder support part 496 in a direction in which the separation roller 603c contacts the feed roller 603b, in a state where the storage cassette 602A is attached to the apparatus body 100A. In other words, the separation roller 603c is biased by the separation roller spring 497 in a direction in which the separation roller 603c contacts the feed roller 603b via the holder support part 496. Through this, when the printing apparatus 1A performs feed operations, the separation roller 603c can separate the sheets SH by pressing against the feed roller 603b to form a nip.

The support part 410a is supported by the separation part support part 410. The support part 410a rotatably supports the cover part 411. The cover part 411 is a cover capable of rotating about the support part 410a. The dotted line in FIG. 18 illustrates an attitude to which the cover part 411 has been rotated. The worker can expose the separation roller holder 95 by rotating the cover part 411. The worker can then remove the separation roller holder 95 and replace the separation roller 603c.

The storage cassette 602A includes a sound absorbing material 450 and a cover part 451. The sound absorbing material 450 is provided in a position relatively close to the separation roller 603c. Providing the sound absorbing material 450 in the storage cassette 602A in this manner makes it possible to suppress the leakage of feed noise to the exterior of the printing apparatus 1A when the separation roller 603c and the feed roller 603b contact each other to feed the sheets SH.

The switching mechanism 405 will be described with reference to FIGS. 17A and 17B. FIGS. 17A and 17B are cross-sectional views along F-F in FIG. 16.

The switching mechanism 405 is linked to the rotation of the separation follower 400, and switches the position of the separation roller 603c between a contact position where the separation roller 603c is in contact with the feed roller 603b (FIG. 17A) and a separated position where the separation roller 603c is separated from the feed roller 603b (FIG. 17B). By the switching mechanism 405 switching the position of the separation roller 603c in this manner, conveyance resistance in the sheets SH, which occurs when the separation roller 603c contacts the feed roller 603b, can be reduced.

The switching mechanism 405 includes a gear 405a, a gear 405b, and a gear 405c. The gear 405a is provided on the rotating shaft 403a of the follower support member 403, and rotates in synchronization with the rotation of the rotating shaft 403a. The gear 405a meshes with each of the gear 405b and the gear 405c. In other words, the gear 405a can also be said to be a driving gear for driving each of the gear 405b and the gear 405c by the rotation of the rotating shaft 403a.

The gear 405b rotates with the rotation of the gear 405a when the gear 405a rotates. In other words, the gear 405b is a driven gear. The gear 405b is provided on the rotating shaft 407 that supports the sheet return part 406. When the gear 405b rotates with the rotation of the gear 405a, the rotating shaft 407 also rotates in synchronization therewith. Through this, the position of the sheet return part 406 can be switched to the retracted position and the projecting position.

The gear 405c is a driven gear that rotates with the rotation of the gear 405a when the gear 405a rotates. The gear 405c is connected to the holder support part 496. In other words, when the gear 405c rotates with the rotation of the gear 405a, the holder support part 496 also rotates in synchronization therewith. Through this, the separation roller 603c can be switched to a contact position where the separation roller 603c is in contact with the feed roller 603b, and a separated position where the separation roller 603c is separated from the feed roller 603b.

An example of operations performed when the gear 405a rotates due to the rotation of the separation follower 400 will be described. First, in FIG. 17A, the sheet return part 406 is in the retracted position, and the separation roller 603c is in the contact position where the separation roller 603c can contact the feed roller 603b. In the state illustrated in FIG. 17A, when the gear 405a rotates in the direction R10 in synchronization with the rotation of the rotating shaft 403a, the gears 405b and 405c rotate in a direction R11 in response to the rotation of the gear 405a. When the gear 405b rotates in the direction R11, the sheet return part 406 rotates in the direction R11 via the rotating shaft 407. In addition, when the gear 405c rotates in the direction R11, the holder support part 496 also rotates in the direction R11 in synchronization therewith. The position of the sheet return part 406 is then switched from the retracted position, illustrated in FIG. 17A, to the projecting position projecting into the conveyance path, illustrated in FIG. 17B. The separation roller 603c is also switched from the contact position, illustrated in FIG. 17A, to the separated position, illustrated in FIG. 17B.

In the state illustrated in FIG. 17B, when the gear 405a rotates in the direction opposite from the direction R10, the sheet return part 406 and the separation roller 603c rotate in the direction opposite from the direction R11 due to the switching mechanism 405, and take on the state illustrated in FIG. 17A.

In this manner, when the separation follower 400 rotates, the position of the sheet return part 406 is switched between the retracted position and the projecting position by the switching mechanism 405. The position of the separation roller 603c is also switched between the contact position and the separated position by the switching mechanism 405.

Note that the storage cassette 501 described above has the same configuration as the storage cassette 602A. In other words, the storage cassette 501 includes a separation roller capable of separating, a sheet return part, a separation follower, and the like. Furthermore, the optional apparatus 500 includes a cam (not shown) that rotates the separation follower in the same manner as in the apparatus body 100A.

### Configuration Around Feed Roller

The configuration around the feed roller 603b will be described here with reference to FIG. 21. FIG. 21 is a schematic diagram illustrating the configuration around the feed roller 603b, and corresponds to a perspective view of part of the interior of the apparatus body 100A when the storage cassette 602A is attached to the apparatus body 100A. Note that in FIG. 21, the separation roller 603c on the storage cassette 602A side is illustrated in order to explain the operations of the feed roller 603b.

The apparatus body 100A includes a rotating shaft 204 that rotatably supports the feed roller 603b, the L-side cam 201, and an R-side cam 208. The rotating shaft 204 is connected to the feed motor 622A, which is a drive source, by a drive transmission unit 622. The rotating shaft 204 is capable of rotating a direction R3 and a direction R4 opposite from the direction R3 by driving the feed motor 622A. The feed roller 603b, the L-side cam 201, and the R-side cam 208 provided on the rotating shaft 204 each rotates in synchronization with the rotation of the rotating shaft 204. In other words, the L-side cam 201 rotates in synchronization with the feed roller 603b. Likewise, the R-side cam 208 rotates in synchronization with the feed roller 603b. The L-side cam 201 includes a cam face 201a that contacts the pressure plate separation mechanism 97 and a cam face 201b that contacts the separation follower 400. The cam face 201a and the cam face 201b are formed at different positions in the X direction. The cam face 201b is formed in a position opposite the separation follower 400 when the storage cassette 602A is attached to the apparatus body 100A. The R-side cam 208 includes a cam face 201 that contacts the pressure plate separation mechanism 97. Note that the separation follower 400 and the pressure plate separation mechanism 97 are disposed at different positions in the X direction.

The apparatus body 100A includes a drive transmission unit 300 that transmits drive force from the feed motor 622A, which is a drive source, to the feed roller 603b and the feed roller 603a. The drive transmission unit 300 includes a gear 301a that rotates under the drive force from the feed motor 622A, and a gear 301b that rotates in synchronization with the feed roller 603b. In other words, the gear 301a and the gear 301b are rotating members. The gear 301a meshes with a gear 301c provided at an end of the rotating shaft 204. Through this, the drive force from the feed motor 622A is transmitted by the drive transmission unit 300 to the rotating shaft 204 that supports the feed roller 603b. The drive force from the feed motor 622A can then be transmitted to the feed roller 603b and the feed roller 603a via the rotating shaft 204. The drive transmission unit 300 also includes a delay mechanism 301 (described later).

The apparatus body 100A includes a rotation position sensing unit 303 for sensing the rotation position of the feed roller 603b. The rotation position sensing unit 303 is provided on the rotating shaft 204 that supports the feed roller 603b, and senses the rotation position of the rotating shaft 204. The printing apparatus 1A manages the rotation position of the feed roller 603a on the basis of the rotation position of the rotating shaft 204 sensed by the rotation position sensing unit 303. The rotation position sensing unit 303 includes a sensed member 303a and a sensor 303b. The sensed member 303a is, for example, a sensor flag that rotates with the rotating shaft 204. The sensor 303b detects the rotation position of the sensed member 303a, for example. The sensor 303b is, for example, an optical sensor, and includes a light-emitting element such as an LED as well as a light-receiving element.

Note that parts that support gears, path forming members that form conveyance paths for the sheets SH, and the like are not illustrated in FIG. 21. Although a plurality of gears are illustrated as an example of components that transmit the drive force from the feed motor 622A to the two feed rollers 603a and 603b, the drive force may be transmitted by another transmission member such as a belt or the like.

### Rotation of Separation Follower and Raising/Lowering of Pressure Plate

Rotating operations of the separation follower 400 and raising and lowering operations of the pressure plate 91 will be described next. Refer to FIGS. 19A to 19C. FIGS. 19A to 19C are diagrams illustrating rotating operations of the separation follower 400 and raising and lowering operations of the pressure plate 91.

FIG. 19A illustrates a state around the L-side cam 201 when the printing apparatus 1A starts sheet feed operations. When the printing apparatus 1A starts the sheet feed operations, the L-side cam 201 rotates in the direction R3 in response to a motor 622 being driven. As the L-side cam 201 rotates in the direction R3, the cam face 201a and the pressure plate separation mechanism 97 start contacting each other.

FIG. 19B illustrates a state around the L-side cam 201 when the L-side cam 201 rotates further in the direction R3 from the state illustrated in FIG. 19A. The pressure plate separation mechanism 97 lowers in a direction ZI due to the rotational force of the cam face 201a. The engagement part 97a of the pressure plate separation mechanism 97 then engages with the engagement part of the pressure plate 91. As the pressure plate separation mechanism 97 lowers, the pressure plate 91 also lowers. As a result, the pressure plate 91 separates from the feed roller 603a.

FIG. 19C illustrates a state around the L-side cam 201 when the L-side cam 201 rotates further in the direction R3 from the state illustrated in FIG. 19B. When the L-side cam 201 rotates in the direction R3, the cam face 201b and the separation follower 400 contact each other. In other words, when the L-side cam 201 rotates in the direction R3, the cam face 201a moves the storage cassette 602A downstream in what is the removal direction (the −Y direction) when the storage cassette 602A is removed from the apparatus body 100A, and contacts the separation follower 400. The separation follower 400 then rotates under the rotation of the L-side cam 201. The contact part 400b of the separation follower 400 and the contact part 403c of the follower support member 403 contact each other. Accordingly, the follower support member 403 also rotates in the direction R10 due to the rotation of the separation follower 400. As such, the switching mechanism 405 connected to the follower support member 403 moves in tandem, and the sheet return part 406 and the holder support part 496 are rotated as a result. Through this, a switching operation for the position of the sheet return part 406, and a switching operation for switching the separation roller 603c between the contact position and the separated position, are performed.

The direction R3 in which the L-side cam 201 rotates is a direction in which the cam face 201b moves the tip part 400a of the separation follower 400 downstream in a direction Y1. The direction Y1 is the direction in which the storage cassette 602A is removed from the apparatus body 100A. In addition, when the storage cassette 602A is attached to the apparatus body 100A, the rotational center of the separation follower 400 is located further downstream in the −Y direction than the rotational center of the L-side cam 201. Note that the configuration is not limited to one in which the rotational center of the separation follower 400 is located further downstream in the −Y direction than the rotational center of the L-side cam 201. The separation follower 400 rotates along with the rotating L-side cam 201, such that the tip part 400a moves downstream in the direction Y1. Accordingly, when the cam face 201b and the tip part 400a contact each other, the contact surface of the cam face 201b is located further upstream in the direction Y1 than the tip part 400a of the separation follower 400. Accordingly, when the storage cassette 602A is removed from the apparatus body 100A, the tip part 400a of the separation follower 400 moves in a direction away from the cam face 201b (the direction Y1). This makes it possible to prevent the L-side cam 201 and the separation follower 400 from interfering with each other when the storage cassette 602A is removed from the apparatus body 100A.

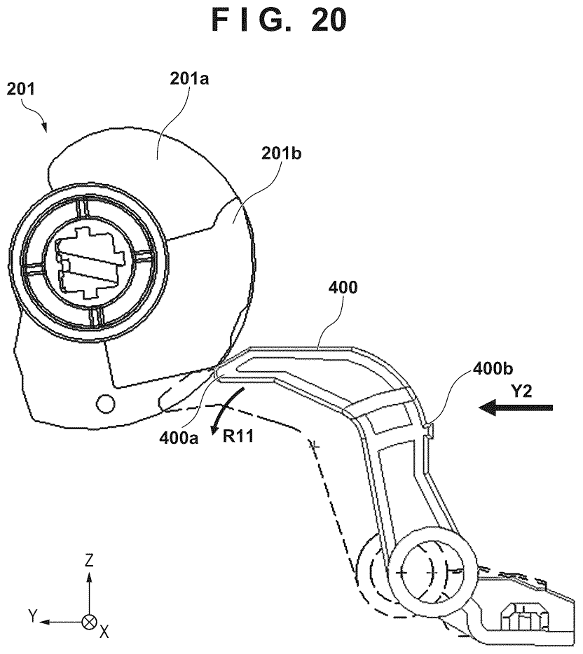

Refer now to FIG. 20 as well. FIG. 20 is a schematic diagram illustrating the separation follower 400 and the L-side cam 201 while the storage cassette 602A is being attached to the apparatus body 100A. The dotted line in the drawing represents the separation follower 400 when the storage cassette 602A is completely attached. As illustrated in FIG. 20, when the storage cassette 602A is attached to the apparatus body 100A, depending on the attitude of the L-side cam 201, the separation follower 400 contacts the L-side cam 201 and is subjected to a force in the direction R11. As described above, the separation follower 400 is supported by the follower support member 403 so as to be rotatable about the X axis, and is biased in the direction R10 by the separation follower spring 402. Accordingly, when the separation follower 400 is subjected to a force in the direction R11, the separation follower 400 rotates in the direction R11, but the follower support member 403 does not rotate.

In addition, as described above, the follower support member 403 is biased to rotate in the direction R11, and contacts the storage cassette 602A. Accordingly, if the separation follower 400 and the follower support member 403 are configured in an integrated manner, the separation follower 400 and the follower support member 403 cannot rotate in the direction R11 as indicated by the dotted line in FIG. 21. Accordingly, the storage cassette 602A may not be moved to a completely-attached position, or a large force may be applied and the separation follower 400 may be damaged. In the present embodiment, the separation follower 400 is rotatably supported by the follower support member 403 in the present embodiment, and the storage cassette 602A can therefore be attached with the L-side cam 201 in any attitude.

### Feed Operations

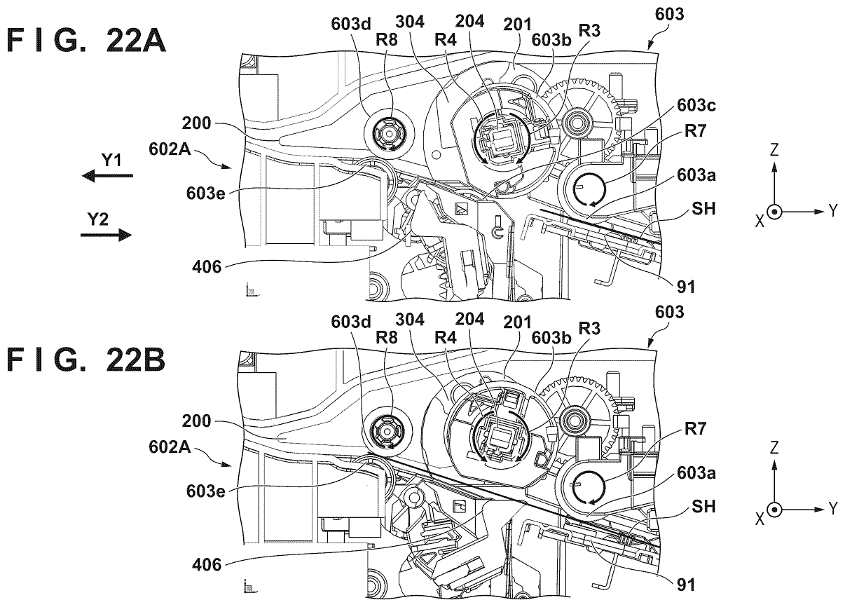

Feed operations will be described in detail with reference to FIGS. 22A and 22B. FIGS. 22A and 22B are cross-sectional views of the feed unit 603.

FIG. 22A illustrates a first state of the feed unit 603 before printing operations are started and after printing operations are complete. In other words, the first state is a standby state in which the feed unit 603 is standing by to feed the sheets SH. In the first state, the sheet return part 406 is switched to the retracted position. In the first state, the separation roller 603c is switched to the contact position where the separation roller 603c is in contact with the feed roller 603b. In the first state, the rotation position of the feed roller 603b is located at a feed start position. The feed roller 603b is formed having a D-shaped cross-section, with an arc part formed in an arc shape and a flat part. In the first state, the feed roller 603b contacts the separation roller 603c at one end of the arc part on the outer circumferential surface thereof, which is a feed surface for the sheets SH. In the first state, the feed roller 603a and the pressure plate 91 are in contact. The storage cassette 602A is attached to and removed from the apparatus body 100A in the first state.

FIG. 22B illustrates a second state of the feed unit 603. The second state is a state from after the feed operations are complete to before the feed operations of the next sheet are performed, when the feed unit 603 performs feed operations for feeding a plurality of the sheets SH. In the second state, the sheet SH is conveyed by the feed roller 603b and the separation roller 603c, and is then conveyed by a roller pair downstream in the conveyance path (e.g., the feed roller 603d and the feed roller 603c). In the second state, the sheet return part 406 is switched to the projecting position. In the second state, the separation roller 603c is switched to the separated position separated from the feed roller 603b. In the second state, the feed roller 603a and the pressure plate 91 are separated from each other. Additionally, in the second state, the flat part of the feed roller 603b is opposite the separation roller 603c.

The feed operations will be described in detail next. When a command to perform feed operations is received, the printing apparatus 1A drives the feed motor 622A, rotates the feed rollers 603a, 603b, and 603c, and feeds the sheet SH. The direction of rotation of the feed motor 622A at this time will be called a direction R5. Specifically, the printing apparatus 1A rotates the feed roller 603a in a direction R7. The printing apparatus 1A rotates the feed roller 603b in the direction R3. The printing apparatus 1A rotates the feed roller 603c in the direction R7.

While the feed roller 603b is rotated by a predetermined amount in the direction R3 and transitions from the first state to the second state, the sheet below the uppermost sheet SH stops at the nip between the separation roller 603c and the feed roller 603b due to resistance from the separation roller 603c. Then, after the separation roller 603c separates, the sheet below the uppermost sheet SH that stopped at the nip is returned to the stacking part 700 by the sheet return part 406. As a result, only the uppermost sheet SH is fed.

After the feed roller 603b transitions to the second state, the printing apparatus 1A drives the feed motor 622A in the direction opposite from the direction R5 (called a “direction R6” hereinafter). The printing apparatus 1A then rotates the feed roller 603d in a direction R8, and feeds the sheet SH to the feed unit 604. At this time, the separation roller 603c is in the separated position, separated from the feed roller 602b. Through this, the conveyance resistance on the sheet SH can be reduced when the feed roller 603d, which is disposed on the downstream side in the conveyance path, feeds the sheet SH. Additionally, the feed roller 603a and the pressure plate 91 are separated. This makes it possible to reduce the load on the sheet SH that is fed.

Feed operations for feeding a plurality of sheets SH will be described next. The sheet return part 406, the feed roller 603a, the feed roller 603b, the separation roller 603c, and the pressure plate 91 are in the first state when the feed operations for a plurality of sheets are started.

When a command to perform feed operations is received, the printing apparatus 1A drives the feed motor 622A to rotate in the direction R5. The printing apparatus 1A then feeds the sheet SH by rotating the three feed rollers 603a, 603b, and 603d in the direction R7, the direction R3, and the direction R8, respectively. As when feeding the first sheet, only the uppermost sheet SH is fed during the transition from the first state to the second state. The printing apparatus 1A then feeds the next sheet SH. The foregoing operations are repeated to perform the feed operations for feeding a plurality of sheets. When the feed operations for the number of sheets SH for which the command was received are complete, the printing apparatus 1A drives the feed motor 622A, and switches the sheet return part 406, the feed roller 603a, the feed roller 603b, the separation roller 603c, and the pressure plate 91 from the second state to the first state.

In this manner, the separation roller 603c separates from the feed roller 603b when a single sheet SH is fed to the feed roller 603d, which is disposed downstream in the conveyance path. This makes it possible to reduce the conveyance resistance when conveying the sheet SH. Reducing the conveyance resistance makes it possible to reduce the amount of power required to feed a single sheet. Doing so also suppresses wear on the separation roller 603c and prolongs the lifespan thereof.

Note that the storage cassette 501 also includes a separation roller that can be separated, in the same manner as in the storage cassette 602A, and the same effects can be achieved.

### Removal of Storage Cassette and Rotation Position of Feed Roller

The state of the feed roller 603b when the storage cassette 602A is attached to the apparatus body 100A will be described further with reference to FIG. 22A. As described above, the feed roller 603a and the feed roller 603b are attached to the apparatus body 100A. The separation roller 603c is attached to the storage cassette 602A. While the storage cassette 602A is attached to the apparatus body 100A, the separation roller 603c is biased by the separation roller spring 497 in a direction in which the separation roller 603c contacts the feed roller 603c. Accordingly, when the storage cassette 602A is removed from the apparatus body 100A in the direction Y1, the feed roller 603b is in the first state and is rotated in the direction R3 by the separation roller 603c that is in contact therewith.

In this manner, when the storage cassette 602A is attached to the apparatus body 100A, the rotation position of the feed roller 603b is sometimes shifted from the first state, which is the standby state, by the separation roller 603c. When the rotation position of the feed roller 603b is shifted, the amounts by which the sheets SH are conveyed by the feed roller 603b and the separation roller 603c may fluctuate, the timing at which the separation roller 603c is separated by the switching mechanism 405 may shift, and the like, for example. As a result, during feeding, the sheets SH may be fed in multiple, or may not be fed at all. A technique for suppressing shift in the rotation position of the feed roller 603b is therefore needed.

### Regulating Unit

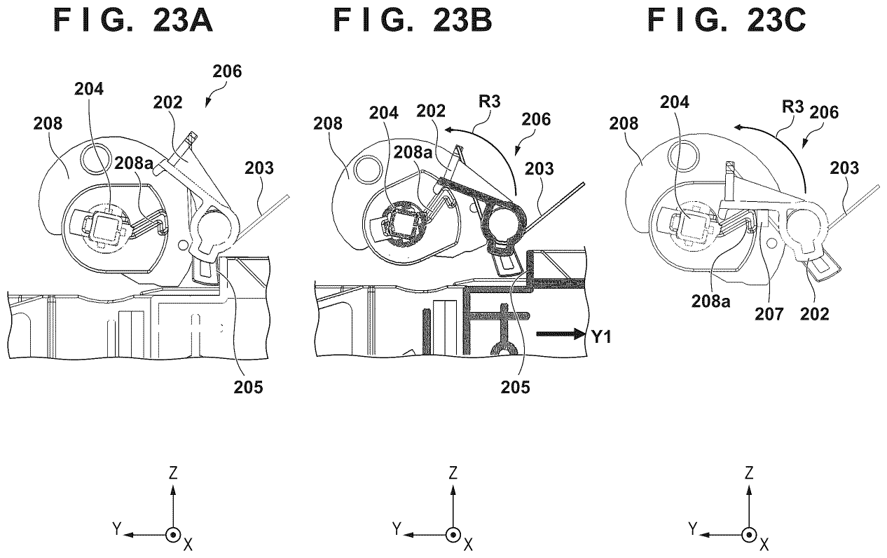

The regulating unit 206 will be described here. FIGS. 23A to 23C are diagrams illustrating operations of the regulating unit 206. As described above, the apparatus body 100A includes the regulating unit 206 near the R-side cam 208. The regulating unit 206 regulates the rotation of the feed roller 603b when the storage cassette 602A is removed from the apparatus body 100A. This makes it possible to suppress shifts in the rotation position of the feed roller 603b.

The regulation of the rotation of the feed roller 603b will be described in detail here. As illustrated in FIGS. 23A to 23C, the apparatus body 100A includes an engagement member 208a provided on the rotating shaft 204 of the feed roller 603b. In the present embodiment, the engagement member 208a is formed integrally with the R-side cam 208. The regulating unit 206 includes a rotation position return lever 202 rotatably supported by the support member 200 and capable of engaging with the engagement member 208a, and a rotation position return spring 203 that biases the rotation position return lever 202. The rotation position return lever 202 rotates in the direction R3 under the bias of the rotation position return spring 203.

FIG. 23A illustrates the state of the regulating unit 206 when the storage cassette 602A is attached to the apparatus body 100A. The rotation position return lever 202 attempts to rotate in the direction R3 under the bias of the rotation position return spring 203. However, when the storage cassette 602A is attached to the apparatus body 100A, the rotation position return lever 202 contacts a contact surface 205 provided in the storage cassette 602A. Accordingly, the rotation position return lever 202 retracts to a position where the rotation of the cam is not regulated. In other words, the regulating unit 206 cancels the rotation regulation of the feed roller 602b when the storage cassette 602A is attached to the apparatus body 100A. The printing apparatus 1A performs feed operations in this state.

FIG. 23B illustrates the state of the regulating unit 206 while the storage cassette 602A is being pulled out from the apparatus body 100A. As described above, the separation roller 603c is pressed against the feed roller 603b, and thus the feed roller 603b rotates in the direction R3 (see FIGS. 22A and 22B). The R-side cam 208 then rotates in the direction R3 in synchronization with the rotation of the feed roller 603b. Because the contact surface 205 moves in the direction Y1, the rotation position return lever 202 is rotated by the rotation position return spring 203 to a position where the rotation of the R-side cam 208 in the direction R3 is regulated. In other words, the regulating unit 206 regulates the rotation of the feed roller 603b by engaging the rotation position return lever 202 with the engagement member 208a in conjunction with the removal of the storage cassette 602A from the apparatus body 100A.

FIG. 23C illustrates the state of the regulating unit 206 when the storage cassette 602A is removed from the apparatus body 100A. The rotation position return lever 202 regulates the rotation of the R-side cam 208 in the direction R3. In addition, the rotation position return lever 202 is biased in the direction R3 by the rotation position return spring 203. Note that the rotation position return lever 202 is fixed in a state of contact with a contact surface 207 provided in the support member 200. Through this, the feed roller 603b can return to the first state even if the feed roller 603b rotates due to contacting the separation roller 603c when the storage cassette 602A is pulled out. Accordingly, after the storage cassette 602A is pulled out, shift in the rotation position of the feed roller 603b, from the first state, can be corrected to suppress the occurrence of feed defects. Additionally, for example, the rotation of the feed roller 603b can be regulated even if a user rotates the feed roller 603b in the direction R3 while the storage cassette 602A is removed from the apparatus body 100A.

### Delay Mechanism

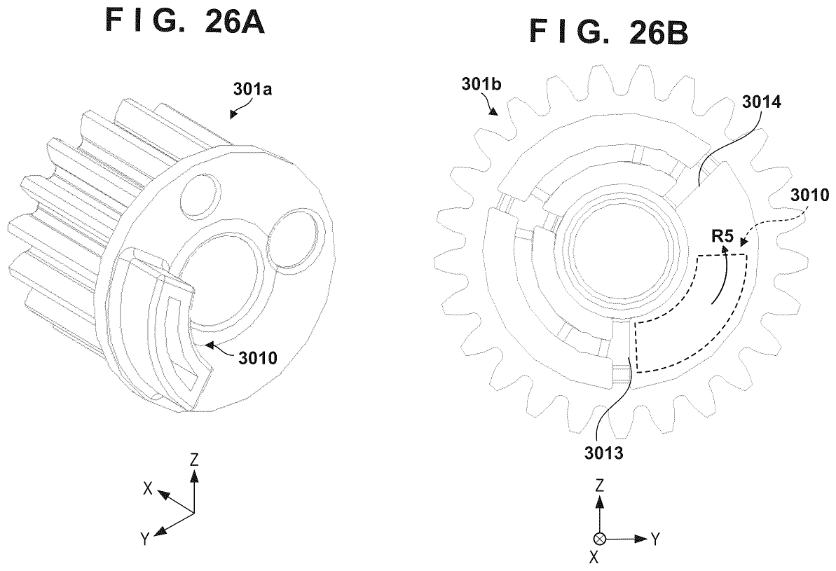

The delay mechanism 301 illustrated in FIG. 21 will be described here with reference to FIGS. 26A and 26B. FIGS. 26A and 26B are schematic diagrams illustrating the delay mechanism 301, and correspond to diagrams illustrating the internal configurations of the gear 301a and the gear 301b.

The delay mechanism 301 includes the gear 301a and the gear 301b. The gear 301a includes an engagement part 3010. The engagement part 3010 can also be said to be a projecting part that projects from one surface of the gear 301a (a surface opposite the gear 301b). The gear 301b includes an engagement part 3013 and an engagement part 3014 distanced from each other in the circumferential direction. The engagement part 3013 and the engagement part 3014 are side walls of a groove 3014 formed in a part of one surface of the gear 301b in the circumferential direction thereof (a surface opposite the gear 301a). The groove 3014 is formed such that the amount by which the gear 301a rotates from the state in which the engagement part 3010 and the engagement part 3013 are in contact, to when the engagement part 3010 and the engagement part 3014 are in contact, is greater than the amount by which the feed roller 603b rotates in the direction R3 when the storage cassette 602A is pulled out.

For example, when the gear 301b rotates in the direction opposite to the direction R5 due to the drive force from the feed motor 622A, the engagement part 3010 and the engagement part 3014 separate, and the engagement part 3010 and an engagement part 3011 engage, which transmits the drive force from the feed motor 622A. On the other hand, when the drive force is transmitted from the feed roller 603b to the feed motor 622A (when the storage cassette 602A is pulled out), the gear 301a rotates in the direction R5, as illustrated in FIG. 26B. In this case, the engagement part 3010 and the engagement part 3014 engage, and the engagement part 3010 and the engagement part 3013 separate. In other words, when the gear 301b rotates, it takes time to contact the gear 301a. Likewise, when the gear 301a rotates, it takes time to contact the gear 301b.

The amount of rotation over which the drive is not transmitted between the gear 301a and the gear 301b is called a “delay amount”. The delay mechanism 301 is provided with a delay amount that is greater than the amount by which the feed roller 603b rotates in the direction R3 when the storage cassette 602A is pulled out. Accordingly, when the feed roller 603b rotates in the direction R3, the delay amount is consumed by the delay mechanism 301. In other words, the delay mechanism 301 delays the transmission of the drive force from the feed roller 603b side to the feed motor 622A, which is the drive source. It can also be said that the delay mechanism 301 temporarily blocks the drive force to a drive train (gears, belts, and the like; not shown) that connects to the feed motor 622A, and suppresses the drive train from moving. Through this, the feed roller 603b can be rotated smoothly when the storage cassette 602A is removed from the apparatus body 100A and the feed roller 603b is rotated in the direction R4 by the aforementioned regulating unit 206.

Although the present embodiment describes the gear 301a as including the engagement part 3010 and the gear 301b as including the groove 3014, the configuration is not limited thereto. For example, the gear 301a may include the groove 3014 and the gear 301b may include the engagement part 3010. In other words, one of the gear 301a and the gear 301b may include the engagement part 3010, and the other may include the groove 3014.

Initialization Control when Inserting Storage Cassette

For example, when attaching the storage cassette 602A to the apparatus body 100A, if the feed roller 603b is in the first state, the feed roller 603b contacts the separation roller 603c of the storage cassette 602A and rotates in the direction R4 (see FIG. 22A). Accordingly, when the storage cassette 602A is attached to the apparatus body 100A, the rotation position of the feed roller 603b may shift from the first state. Accordingly, when the storage cassette 602A is attached, the printing apparatus 1A performs control for putting the feed roller 603b into a predetermined rotation position (the first state).

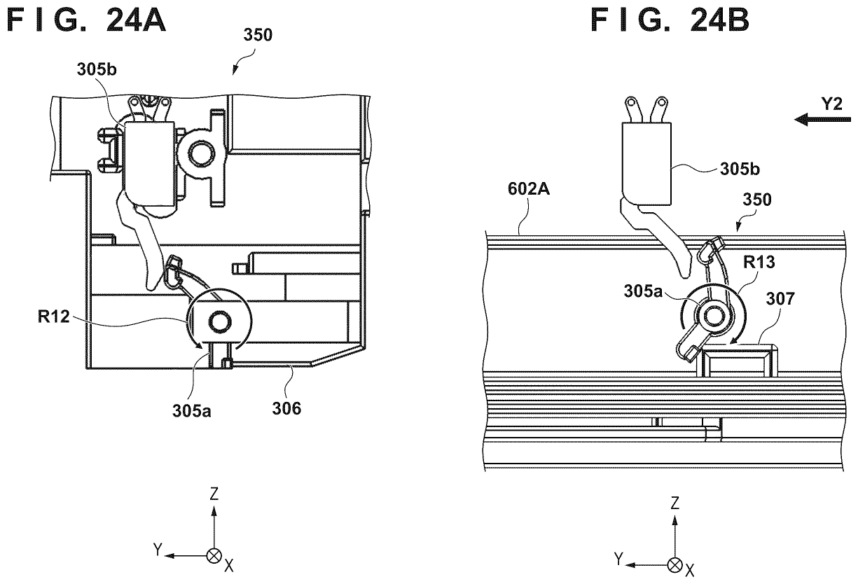

Here, the descriptions will refer to FIGS. 24A and 24B. FIGS. 24A and 24B are explanatory diagrams illustrating sensing operations for sensing that the storage cassette 602A has been attached to the apparatus body 100A.

FIG. 24A illustrates part of the configuration of the slot SL1 when the storage cassette 602A is removed from the printing apparatus 1A. The apparatus body 100A includes a cassette sensing unit 350 that senses the attachment of the storage cassette 602A to the apparatus body 100A. The cassette sensing unit 350 is attached to a support member 306 provided on a side wall of the slot SL1. As will be described later, the CPU of the printing apparatus 1A executes initialization control when the cassette sensing unit 350 senses that the state of the printing apparatus 1A has become a state where the storage cassette 602A is attached to the apparatus body 100A.

The cassette sensing unit 350 includes a lever 305a and a switch 305b. The lever 305a is biased by a spring (not shown) to rotate in a direction R12 while the storage cassette 602A is removed from the apparatus body 100A. In other words, the lever 305a is biased by the spring (not shown) so as to tilt downstream in the removal direction when the storage cassette 602A is removed from the apparatus body 100A. The position of the lever 305a is determined as illustrated in FIG. 24A by one end of the lever 305a contacting the support member 306. In this position, the lever 305a is in a state where the switch 305b is pushed (on). As a result, the switch 305b senses that the storage cassette 602A is not attached to the apparatus body 100A.

FIG. 24B illustrates the state of the cassette sensing unit 350 when the storage cassette 602A is attached to the apparatus body 100A. Note that the support member 306 is not illustrated in FIG. 24B. When the storage cassette 602A is attached to the apparatus body 100A, the storage cassette 602A moves in a direction Y2. When the storage cassette 602A moves in the direction Y2, a protruding part 307 provided in the storage cassette 602A contacts the lever 305a. When the storage cassette 602A moves further in the direction Y2, the lever 305a is pushed by the protruding part 307 and rotates in a direction R13. When the lever 305a rotates in the direction R13, the lever 305a separates from the switch 305b. As a result, the switch 305b moves from the state of being pushed (on) to the state of not being pushed (off). As a result, the switch 305b senses that the storage cassette 602A is attached to the apparatus body 100A.

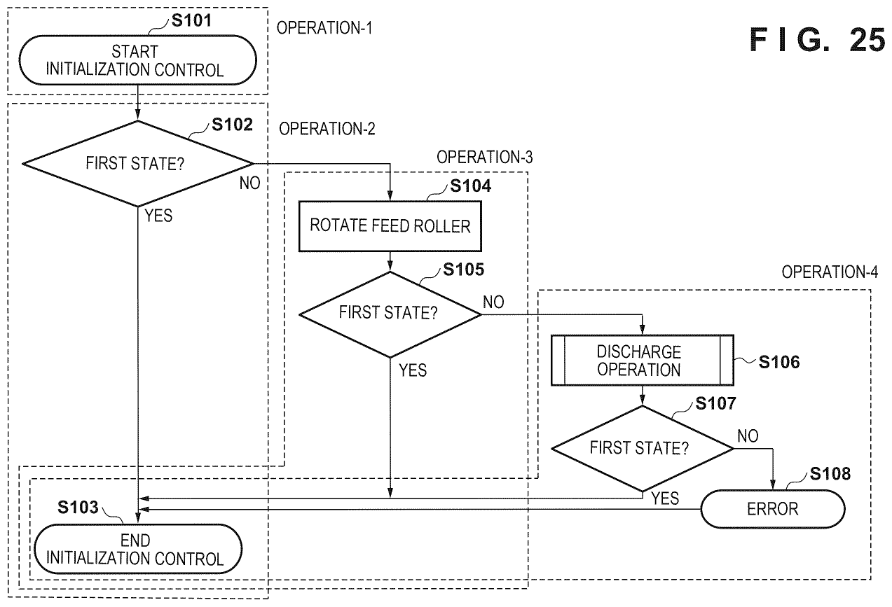

FIG. 25 is a flowchart illustrating an example of processing for initialization control in which the printing apparatus 1A controls the rotation position of the feed roller 603b. Typically, this flowchart can be performed by a central processing unit (CPU) built into the printing apparatus 1A reading out a program, loading the program into memory, and executing the program. As described above, when the storage cassette 602A is attached to the apparatus body 100A, the rotation position of the feed roller 603b may change from the first state (FIG. 22A). If the rotation position of the feed roller 603b remains shifted, normal feed operations may not be able to be performed. Accordingly, in the present embodiment, the printing apparatus 1A performs initialization control for controlling the rotation position of the feed roller 603b to a predetermined position (the first state) when the state of the printing apparatus 1A has become a state where the storage cassette 602A is attached to the apparatus body 100A. This makes it possible to suppress shifts in the rotation position of the feed roller 603b.

In step S101, the printing apparatus 1A starts initialization control operations on the basis of the cassette sensing unit 350 sensing that the storage cassette 602A has been attached to the apparatus body 100A.

In step S102, the printing apparatus 1A determines whether the rotation position of the feed roller 603b is in the first state (FIG. 22A) on the basis of the sensing result from the rotation position sensing unit 303. If the printing apparatus 1A determines the rotation position is in the first state, the sequence moves to step S103 and the initialization control operations end. However, if the printing apparatus 1A determines that the rotation position is not in the first state, the sequence moves to step S104.

In step S104, the printing apparatus 1A drives the feed motor 622A by a predetermined drive amount to rotate the rotation position of the feed roller 603b in the direction R3 so as to enter the first state. In other words, because the feed roller 603b may rotate in the direction R4 when the storage cassette 602A is attached, the printing apparatus 1A rotates the feed roller in the direction R3 opposite from the direction R4. Specifically, the printing apparatus 1A rotates the feed roller 603b in the direction R3 by a second drive amount, which is lower than a first drive amount used when rotating the feed roller 603b by one rotation.

The amount by which the rotation position of the feed roller 603b shifts due to the storage cassette 602A being attached and removed is assumed to be, for example, a relatively small amount within the rotation range of 360 degrees (e.g., between several degrees and ten to twenty degrees). Accordingly, in step S104, the printing apparatus 1A first rotates the feed roller 603b by the second drive amount in order to correct a such a small amount of shift. When the amount of shift in the rotation position of the feed roller 603b is small, control such as that performed in step S104 makes it possible to return the feed roller 603b to the first state from, for example, a state in which the feed roller 603b is separated (a state in which sheets are not conveyed). Additionally, by rotating the feed roller 603b by a second drive amount, the printing apparatus 1A can prevent sheets SH stored in the storage cassette 602A from being fed unnecessarily.

In step S105, the printing apparatus 1A determines whether the rotation position of the feed roller 603b has entered the first state from a predetermined drive amount. If the printing apparatus 1A determines that the rotation position has entered the first state, the initialization control operations end. However, if the printing apparatus 1A determines that the rotation position is not in the first state, the sequence moves to step S106.

In step S106, the printing apparatus 1A rotates the feed roller 603b further by driving the feed motor 622A by a predetermined drive amount, taking the drive amount equivalent to one rotation of the feed roller 603b as an upper limit. For example, it is assumed that when the user removes the storage cassette 602A from the apparatus body 100A and touches the feed roller 603b, the amount of shift in the rotation position of the feed roller 603b is assumed to be greater than the amount of shift occurring when the storage cassette 602A is attached and removed. Accordingly, the printing apparatus 1A can correct the rotation position of the feed roller 603b by executing the control in S106.

Note that in step S106, when the printing apparatus 1A executes the control described above to return the rotation position of the feed roller 603b to the first state, a sheet SH stacked in the storage cassette 602A may be fed. If a sheet SH is fed, the sheet SH will remain in the conveyance path even if the feed roller 603b enters the first state, and the printing apparatus 1A therefore cannot start the feed operations normally.

Accordingly, in step S106, the printing apparatus 1A performs operations for discharging print sheets from the conveyance path as necessary. In step S106, the printing apparatus 1A determines whether operations for discharging a sheet SH are necessary using a sensor or the like that senses the presence or absence of sheets, provided in the printing apparatus 1A. If the printing apparatus 1A determines that discharge operations are not necessary, the sequence moves to step S107. However, if the printing apparatus 1A determines that discharge operations are necessary, the discharge operations are executed. Specifically, the printing apparatus 1A performs operations for discharging the sheet SH such that the rotation position of the feed roller 603b enters the first state (see FIG. 22A).

In step S107, the printing apparatus 1A determines whether the rotation position of the feed roller 603b is in the first state (FIG. 22A) on the basis of the sensing result from the rotation position sensing unit 303. If the printing apparatus 1A determines the rotation position is in the first state, the sequence moves to step S103 and the initialization control operations end. However, if the printing apparatus 1A determines that the rotation position is not in the first state, the sequence moves to step S108.

In step S108, the printing apparatus 1A determines that some kind of anomaly has occurred in the printing apparatus 1A, and notifies the user of an error. For example, the printing apparatus 1A may display an error message on a display unit (not shown), communicate the error as audio using a speaker (not shown), or the like.

In this manner, the printing apparatus 1A can return the rotation position of the feed roller 603b to the first state with a relatively simple configuration and control when the storage cassette 602A is attached to the apparatus body 100A. As a result, situations where the sheets SH are fed in multiple or not fed at all due to the rotation position of the feed roller 603b being shifted are suppressed, which makes it possible to feed the sheets SH in a stable manner.

Although the present embodiment describes the printing apparatus 1A as starting the initialization control when the storage cassette 602A is attached to the apparatus body 100A, the configuration is not limited thereto. The printing apparatus 1A may start the initialization control when, for example, the state of the printing apparatus 1A is a state in which feeding of the sheets SH by the feed roller 603b is complete. Through this, even if the rotation position of the feed roller 603b has shifted, e.g., when the feed operations are complete, the rotation position can be corrected.

The printing apparatus 1A may also start the initialization control when the power of the printing apparatus 1A is turned on, for example. Through this, even when, for example, the power of the printing apparatus 1A is turned off, the storage cassette 602A is attached to or removed from the apparatus body 100A, and the rotation position of the feed roller 603b has shifted, the rotation position can be corrected.

The printing apparatus 1A may also be configured to sense the attachment of the storage cassette 602A to the apparatus body 100A in response to a user operating an operation unit (not shown), for example. For example, after the user attaches the storage cassette 602A to the apparatus body 100A, the printing apparatus 1A may execute the initialization control processing when a predetermined user operation is accepted by the operation unit (not shown).

The printing apparatus 1A may also be configured to cancel the initialization control when the storage cassette 602A is sensed to have been removed from the apparatus body 100A during the initialization control.

Although the present embodiment describes the pressure plate 91, which is the stacking part 700, as being raised by a spring (not shown) and lowered by the pressure plate separation mechanism 97, the configuration is not limited thereto. For example, the pressure plate 91 may be raised by a drive source such as a motor or the like to a position where sheets SH can be fed by the pressure plate 91 (a position where the feed roller 603a contacts the sheets SH). The printing apparatus 1A can apply the initialization control even in such a configuration. Additionally, after the initialization control, the printing apparatus 1A performs a raising operation for moving the pressure plate 91 to a position where the pressure plate 91 can feed sheets SH. By performing operations to raise the pressure plate 91 after the initialization control, the printing apparatus 1A can perform the initialization control while the feed roller 603a is separated from the sheets SH. In other words, the initialization control can be performed without discharging sheets SH unnecessarily.

According to the present disclosure, a technique for suppressing shifts in the rotation position of a feed roller can be provided.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-157728, filed Sep. 11, 2024 which is hereby incorporated by reference herein in its entirety.

What is claimed is:

1. A printing apparatus comprising:
a housing;
a feed roller, disposed in the housing, that feeds a sheet;
a printing unit configured to print onto the sheet fed by the feed roller; and
a storage cassette capable of being attached to and removed from the housing, the storage cassette storing the sheet,
wherein the storage cassette includes a sheet separation unit capable of contacting the feed roller, and
the printing apparatus comprises a regulating unit, disposed in the housing, configured to regulate rotation of the feed roller in conjunction with removal of the storage cassette from the housing.

2. The printing apparatus according to claim 1,
wherein the housing includes an engagement member provided on a rotating shaft of the feed roller, and
the regulating unit regulates the rotation of the feed roller by engaging with the engagement member in conjunction with the removal of the storage cassette from the housing.

3. The printing apparatus according to claim 2,
wherein the regulating unit includes:
a lever capable of engaging with the engagement member; and
a biasing unit configured to bias the lever into engaging with the engagement member.

4. The printing apparatus according to claim 1,
wherein the regulating unit stops regulating the rotation of the feed roller when the storage cassette is attached to the housing.

5. The printing apparatus according to claim 2,
wherein the housing includes a drive transmission unit configured to transmit a drive force from a drive source to the feed roller, and
the drive transmission unit includes a delay mechanism that delays transmission of a drive force from the feed roller to the drive source.

6. The printing apparatus according to claim 5,
wherein the delay mechanism includes:
a first rotating member that rotates under a drive force from the drive source; and
a second rotating member that rotates in synchronization with the feed roller,
one of the first rotating member and the second rotating member includes a first engagement part, and an other of the first rotating member and the second rotating member includes a second engagement part and a third engagement part distanced from each other in a circumferential direction,
when the drive source is driven, the first engagement part and the second engagement part engage, and the first engagement part and the third engagement part separate, and
when the drive force is transmitted from the feed roller to the drive source, the first engagement part and the third engagement part engage, and the first engagement part and the second engagement part separate.

7. The printing apparatus according to claim 1, further comprising:
a control unit configured to control a rotation position of the feed roller,
wherein the control unit controls the rotation position of the feed roller to a predetermined position when the printing apparatus is in a state where the storage cassette is attached to the housing.

8. The printing apparatus according to claim 7,
wherein the housing includes a first sensing unit configured to sense attachment of the storage cassette to the housing.

9. The printing apparatus according to claim 7,
wherein the housing includes a second sensing unit configured to sense the rotation position of the feed roller.

10. A printing apparatus comprising:
a housing;
a feed roller, disposed in the housing, that feeds a sheet;
a printing unit configured to print onto the sheet fed by the feed roller; and
a storage cassette capable of being attached to and removed from the housing, the storage cassette storing the sheet,
wherein the storage cassette includes a sheet separation unit capable of contacting the feed roller,
the printing apparatus comprises a control unit, disposed in the housing, configured to control a rotation position of the feed roller, and
the control unit controls the rotation position of the feed roller to a predetermined position when the printing apparatus is in a predetermined state.

11. The printing apparatus according to claim 10,
wherein the predetermined state includes a state in which the storage cassette is attached to the housing.

12. The printing apparatus according to claim 11,
wherein the housing includes a first sensing unit configured to sense attachment of the storage cassette to the housing.

13. The printing apparatus according to claim 10,
wherein the predetermined state includes a state in which feeding of the sheet by the feed roller is complete.

14. The printing apparatus according to claim 10,
wherein the housing includes a second sensing unit configured to sense the rotation position of the feed roller.

15. The printing apparatus according to claim 10,
wherein in the control, the control unit causes the feed roller to rotate by a second drive amount lower than a first drive amount used when rotating the feed roller by one rotation.

16. The printing apparatus according to claim 15,
wherein in the control, when the feed roller does not enter a predetermined rotation position, the control unit causes the feed roller to rotate further up to an upper limit, the upper limit being the first drive amount.

17. The printing apparatus according to claim 10,
wherein the housing includes a pickup roller disposed further upstream than the feed roller in a feed direction of the sheet, the pickup roller feeding an uppermost sheet stored in the storage cassette to the feed roller.

18. The printing apparatus according to claim 17,
wherein the storage cassette includes a stacking unit on which a sheet is stacked, and
the stacking unit is provided in the storage cassette so as to be capable of being raised and lowered.

19. The printing apparatus according to claim 18, further comprising:
a raising/lowering unit configured to raise and lower the stacking unit,
wherein the stacking unit is raised by the raising/lowering unit after the control by the control unit.

20. A storage cassette capable of being attached to and removed from a housing of a printing apparatus, the storage cassette storing a sheet, the printing apparatus comprising:
a housing;
a feed roller, disposed in the housing, that feeds a sheet;
a printing unit configured to print onto the sheet fed by the feed roller; and
a regulating unit, disposed in the housing, configured to regulate rotation of the feed roller in conjunction with removal of the storage cassette from the housing, and
the storage cassette comprising:
a sheet separation unit capable of contacting the feed roller.

21. A storage cassette capable of being attached to and removed from a housing of a printing apparatus, the storage cassette storing a sheet, the printing apparatus comprising:
a housing;
a feed roller, disposed in the housing, that feeds a sheet;
a printing unit configured to print onto the sheet fed by the feed roller; and
a control unit, disposed in the housing, configured to control a rotation position of the feed roller,
wherein the control unit controls the rotation position of the feed roller to a predetermined position when the printing apparatus is in a predetermined state, and
the storage cassette comprising:
a sheet separation unit capable of contacting the feed roller.
